(19) United States
(12) Patent Application Publication
(10) Pub. No.: US 2017/0248424 A1
(43) Pub. Date: Aug. 31, 2017

(54) ELECTRONIC DEVICE FOR DETERMINING POSITION AND METHOD FOR OPERATING THE SAME

(71) Applicant: Samsung Electronics Co., Ltd, Gyeonggi-do (KR)

(72) Inventors: Nam Joon Park, Gyeonggi-do (KR); Jin-Ik Kim, Seoul (KR); Tae-Ho Kim, Chungcheongbuk-do (KR); Jeong-Min Park, Gyeonggi-do (KR)

(21) Appl. No.: 15/441,203

(22) Filed: Feb. 23, 2017

(30) Foreign Application Priority Data
Feb. 25, 2016 (KR) 10-2016-0022652

(51) Int. Cl. G01C 21/08; G01C 5/06; G01C 21/00

(52) U.S. Cl. CPC G01C 21/08; G01C 21/005; G01C 5/06

(57) ABSTRACT

An electronic device comprises a magnetic sensor, a memory configured to store a first geo-magnetic map and a second geo-magnetic map. The first geo-magnetic map may include geo-magnetic data for each of a plurality of positions at a first altitude in an area and the second geo-magnetic map may include geo-magnetic data for each of a plurality of positions at a second altitude in the area. The electronic device may further include a processor configured to identify an altitude of the electronic device, select one of the first geo-magnetic map and the second geo-magnetic map corresponding to the altitude of the electronic device, compare the selected geo-magnetic map with geo-magnetic data sensed by the magnetic sensor, and provide a position of the electronic device using a result of the comparison.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Feb. 25, 2016 and assigned Serial No. 10-2016-0022652, the entire disclosure of which is incorporated herein by reference.

### TECHNICAL FIELD

The present disclosure relates to electronic devices for determining positions and methods for operating the same, and more specifically, to electronic devices for determining positions using geo-magnetic data and methods for operating the same.

### BACKGROUND

There is recently a soaring demand for compact, portable electronic devices, such as smartphones or wearable electronic devices. An electronic device includes a display capable of displaying screens and a communication interface capable of communicating with another electronic device. Thus, the electronic device may run various applications and display information provided from various running applications. A user may easily acquire various pieces of information from the screen displayed on the electronic device. Meanwhile, as electronic devices are made compact enough to carry, they may happen to provide services based on the user's position. For example, an electronic device may provide advertisement information or map information matching the user's position. Such services may be termed location-based services (LBSs).

In order to provide the LBSs, an electronic device should be able to determine the user's position, i.e., the position of the electronic device. Outdoors, an electronic device may determine its position using information obtained from its own GPS module. Indoors, however, the electronic device cannot exactly determine the position with only information obtained from the GPS module. For indoor positioning, technology using geo-magnetic data has been developed. Such technology using geo-magnetic data enables positioning of an electronic device from the characteristic that geo-magnetic data varies depending on positions.

The above information is presented as background information only to assist with an understanding of the present disclosure. No determination has been made, and no assertion is made, as to whether any of the above might be applicable as prior art with regard to the present disclosure.

### SUMMARY

While geo-magnetic data enables positioning of an electronic device, geo-magnetic characteristics may vary depending on altitude even at the position on the same plane. For example, geo-magnetic characteristics may differ at a position with three-dimensional (3D) coordinates (x1,y1,z1) and at a position with 3D coordinates (x1,y1,z2) in an indoor space. Thus, conventional positioning techniques using geo-magnetic data using a two-dimensional (2D) geo-magnetic map cannot give an exact position for an electronic device. In particular, when the height of the electronic device varies significantly, conventional positioning technology using geo-magnetic data fails to calculate the position.

Various embodiments of the present disclosure have been conceived to address the foregoing or other problems. According to embodiments of the present disclosure, there may be provided an electronic device determining a position using one corresponding to the altitude of the electronic device among multiple per-altitude 2D geo-magnetic maps. Additionally, various embodiments of the present disclosure provide various methods for operating the same.

According to an embodiment of the present disclosure, an electronic device includes a magnetic sensor and a memory storing a first geo-magnetic map and a second geo-magnetic map. The first geo-magnetic map may include geo-magnetic data for each of a plurality of positions at a first altitude in an area and the second geo-magnetic map may include geo-magnetic data for each of a plurality of positions at a second altitude in the area. The electronic device may further include a processor configured to identify an altitude of the electronic device and select one of the first geo-magnetic map and the second geo-magnetic map corresponding to the altitude of the electronic device. The processor may also compare the selected geo-magnetic map with geo-magnetic data sensed by the magnetic sensor and provide a position of the electronic device using a result of the comparison.

According to an embodiment of the present disclosure, an electronic device may comprise a magnetic sensor, a communication interface, and a processor. The processor may be configured to identify an altitude of the electronic device, send information on the altitude of the electronic device through the communication interface, and receive a first geo-magnetic map corresponding to the altitude including geo-magnetic data for each of a plurality of positions in an area corresponding to the altitude of the electronic device through the communication interface. The processor may further compare the received first geo-magnetic map with geo-magnetic data sensed by the magnetic sensor and provide a position of the electronic device using a result of the comparison.

According to an embodiment of the present disclosure, a method for operating an electronic device may include identifying an altitude of the electronic device and selecting one of a first geo-magnetic map and a second geo-magnetic map corresponding to the altitude of the electronic device. The first geo-magnetic map may include geo-magnetic data for each of a plurality of positions at a first altitude in an area, and the second geo-magnetic map may include geo-magnetic data for each of a plurality of positions at a second altitude in the area. The method may further include comparing the selected geo-magnetic map with sensed geo-magnetic data and providing a position of the electronic device using a result of the comparison.

According to an embodiment of the present disclosure, a method for operating an electronic device may include identifying an altitude of the electronic device, sensing geo-magnetic data, and sending information on the altitude of the electronic device. The method may further include receiving a geo-magnetic map corresponding to the altitude including geo-magnetic data for each of a plurality of positions in an area corresponding to the altitude of the electronic device. The method may also include comparing the received geo-magnetic map with the sensed geo-magnetic data, and providing a position of the electronic device using a result of the comparison.

According to an embodiment of the present disclosure, an electronic device may include a memory storing a first geo-magnetic map and a second geo-magnetic map. The first geo-magnetic map may include geo-magnetic data for each of a plurality of positions at a first altitude in an area and the second geo-magnetic map may include geo-magnetic data for each of a plurality of positions at a second altitude in the area. The electronic device may further include a processor configured to generate a third geo-magnetic map including geo-magnetic data for each of a plurality of positions at a third altitude between the first altitude and the second altitude using the first geo-magnetic map and the second geo-magnetic map.

According to an embodiment of the present disclosure, a method for operating an electronic device includes obtaining a first geo-magnetic map including geo-magnetic data for each of a plurality of positions at a first altitude in an area and obtaining a second geo-magnetic map including geo-magnetic data for each of a plurality of positions at a second altitude in the area. The method may further include generating a third geo-magnetic map including geo-magnetic data for each of a plurality of positions at a third altitude between the first altitude and the second altitude, using the first geo-magnetic map and the second geo-magnetic map.

According to embodiments of the present disclosure, there may be provided an electronic device configured to determine a position using another position corresponding to the altitude of the electronic device among multiple per-altitude 2D geo-magnetic maps. Other embodiments provide various methods for operating the same.

Various other embodiments, aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device operating in a network according to an embodiment of the present disclosure;

FIG. 2 is a block diagram illustrating an electronic device according to an embodiment of the present disclosure;

FIG. 3 is a block diagram illustrating a program module according to an embodiment of the present disclosure;

FIG. 4 is a flowchart illustrating a method for operating an electronic device according to an embodiment of the present disclosure;

FIG. 5 illustrates a concept view of a 2D geo-magnetic map according to an embodiment of the present disclosure;

FIG. 6 is a flowchart illustrating a method for controlling an electronic device according to an embodiment of the present disclosure;

FIG. 7 illustrates a concept view of a geo-magnetic map according to an embodiment of the present disclosure;

FIG. 8 is a graph illustrating variations in a geo-magnetic characteristic depending on altitudes at one position, according to an embodiment of the present disclosure;

FIG. 9 is a flowchart illustrating an operation of an electronic device according to an embodiment of the present disclosure;

FIG. 10 illustrates a concept view of a plurality of per-altitude geo-magnetic maps, i.e., 3D geo-magnetic maps, according to an embodiment of the present disclosure;

FIG. 11 is a flowchart illustrating an example of obtaining a 3D geo-magnetic map by using an electronic device according to an embodiment of the present disclosure;

FIG. 12 is a flowchart illustrating an example of obtaining a geo-magnetic map according to an embodiment of the present disclosure;

FIG. 13 is a flowchart illustrating a method for operating an electronic device when the altitude of the electronic device varies in a positioning process, according to an embodiment of the present disclosure;

FIG. 14 is a concept view illustrating a per-altitude geo-magnetic map according to an embodiment of the present disclosure;

FIG. 15 is a flowchart illustrating a method for operating an electronic device according to an embodiment of the present disclosure;

FIG. 16 is a flowchart illustrating a method for determining an altitude according to an embodiment of the present disclosure;

FIG. 17 is a flowchart illustrating a method for operating an electronic device according to an embodiment of the present disclosure;

FIG. 18 is a concept view illustrating a swing of an electronic device according to an embodiment of the present disclosure;

FIG. 19 is a concept view illustrating an event of viewing an electronic device according to an embodiment of the present disclosure;

FIG. 20 is a concept view illustrating an event of viewing a wrist watch-type electronic device according to an embodiment of the present disclosure;

FIG. 21 is a flowchart illustrating an example of detecting an event of an electronic device and determining an altitude according to an embodiment of the present disclosure;

FIG. 22 is a concept view illustrating an example of determining an altitude using application execution information according to an embodiment of the present disclosure;

FIG. 23 is a flowchart illustrating an absolute altitude and update of an altitude according to an embodiment of the present disclosure;

FIG. 24 is a flowchart illustrating a method for generating a plurality of per-altitude geo-magnetic maps according to an embodiment of the present disclosure;

FIG. 25 is a concept view illustrating a process for generating a plurality of per-altitude geo-magnetic maps according to an embodiment of the present disclosure;

FIGS. 26a and 26b are graphs illustrating an interpolation method according to an embodiment of the present disclosure;

FIG. 27 is a flowchart illustrating a method for generating a plurality of per-altitude geo-magnetic maps according to an embodiment of the present disclosure;

FIGS. 28a to 28d are concept views illustrating a process for generating a plurality of per-altitude geo-magnetic maps according to an embodiment of the present disclosure;

FIG. 29 is a concept view illustrating a process for updating a geo-magnetic map using crowd sourcing according to an embodiment of the present disclosure;

FIGS. 30a and 30b are concept views illustrating signals according to an embodiment of the present disclosure;

FIG. 31 is a flowchart illustrating a method for updating a geo-magnetic map according to an embodiment of the present disclosure; and

FIG. 32 is a flowchart illustrating an operation of an electronic device performing crowd sourcing according to an embodiment of the present disclosure.

Throughout the drawings, like reference numerals will be understood to refer to like parts, components, and structures.

### DETAILED DESCRIPTION

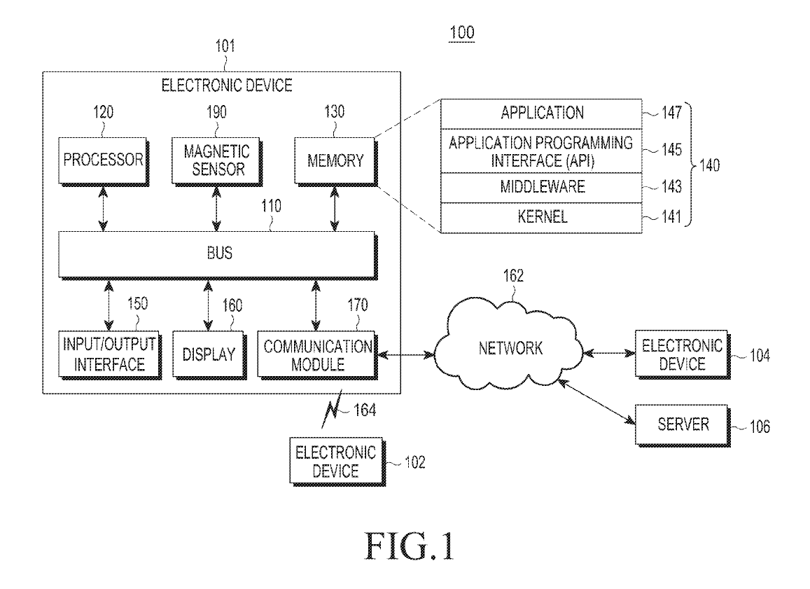

FIGS. 1 through 32, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, embodiments of the present disclosure are described with reference to the accompanying drawings. However, it should be appreciated that the present disclosure is not limited to the embodiments and the terminology used herein, and all changes and/or equivalents or replacements thereto also belong to the scope of the present disclosure. The same or similar reference denotations may be used to refer to the same or similar elements throughout the specification and the drawings. It is to be understood that the singular forms “a,” “an,” and “the” include plural references unless the context clearly dictates otherwise. As used herein, the terms “A or B” or “at least one of A and/or B” may include all possible combinations of A and B. As used herein, the terms “first” and “second” may modify various components regardless of importance and/or order and are used to distinguish a component from another without limiting the components. It will be understood that when an element (e.g., a first element) is referred to as being (operatively or communicatively) “coupled with/to,” or “connected with/to” another element (e.g., a second element), it can be coupled or connected with/to the other element directly or via a third element.

As used herein, the terms “configured to” may be interchangeably used with other terms, such as “suitable for,” “capable of,” “modified to,” “made to,” “adapted to,” “able to,” or “designed to” in hardware or software in the context. Rather, the term “configured to” may mean that a device can perform an operation together with another device or parts. For example, the term “processor configured (or set) to perform A, B, and C” may mean a generic-purpose processor (e.g., a CPU or application processor) that may perform the operations by executing one or more software programs stored in a memory device or a dedicated processor (e.g., an embedded processor) for performing the operations.

For example, examples of the electronic device according to embodiments of the present disclosure may include at least one of a smartphone, a tablet personal computer (PC), a mobile phone, a video phone, an e-book reader, a desktop PC, a laptop computer, a netbook computer, a workstation, a PDA (personal digital assistant), a portable multimedia player (PMP), an MP3 player, a mobile medical device, a camera, or a wearable device. The wearable device may include at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device. In some embodiments, examples of the smart home appliance may include at least one of a television, a digital video disk (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™), a gaming console (Xbox™ PlayStation™, an electronic dictionary, an electronic key, a camcorder, or an electronic picture frame.

According to an embodiment of the present disclosure, examples of the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, drones, automatic teller's machines (ATMs) of financial organizations, point of sales (POS) devices of stores, or Internet of things devices (e.g., a bulb, various sensors, a sprinkler, a fire alarm, a thermostat, a street light, a toaster, fitness equipment, a hot water tank, a heater, or a boiler). According to various embodiments of the disclosure, examples of the electronic device may at least one of part of a piece of furniture, building/structure or vehicle, an electronic board, an electronic signature receiving device, a projector, or various measurement devices (e.g., devices for measuring water, electricity, gas, or electromagnetic waves). According to embodiments of the present disclosure, the electronic device may be flexible or may be a combination of the above-enumerated electronic devices. According to an embodiment of the present disclosure, the electronic device is not limited to the above-listed embodiments. As used herein, the term “user” may denote a human or another device (e.g., an artificial intelligent electronic device) using the electronic device.

Referring to FIG. 1, according to an embodiment of the present disclosure, an electronic device 101 is included in a network environment 100. The electronic device 101 may include a bus 110, a processor 120, a memory 130, an input/output interface 150, a display 160, and a communication interface 170. In some embodiments, the electronic device 101 may exclude at least one of the components or may add another component. For example, the electronic device may include a magnetic sensor 190. The bus 110 may include a circuit for connecting the components 110 to 170 and 190 with one another and transferring communications (e.g., control messages or data) between the components. The processing module 120 may include one or more of a central processing unit (CPU), an application processor (AP), or a communication processor (CP). The processor 120 may perform control on at least one of the other components of the electronic device 101, and/or perform an operation or data processing relating to communication.

The memory 130 may include a volatile and/or non-volatile memory. For example, the memory 130 may store commands or data related to at least one other component of the electronic device 101. According to an embodiment of the present disclosure, the memory 130 may store software and/or a program 140. The program 140 may include, e.g., a kernel 141, middleware 143, an application programming interface (API) 145, and/or an application program (or “application”) 147. At least a portion of the kernel 141, middleware 143, or API 145 may be denoted an operating system (OS). For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example. Further, the middleware 143 may process one or more task requests received from the application program 147 in order of priority. For example, the middleware 143 may assign a priority of using system resources (e.g., bus 110, processor 120, or memory 130) of the electronic device 101 to at least one of the application programs 147 and process one or more task requests. The API 145 is an interface allowing the application 147 to control functions provided from the kernel 141 or the middleware 143. For example, the API 133 may include at least one interface or function (e.g., a command) for filing control, window control, image processing or text control. For example, the input/output interface 150 may transfer commands or data input from the user or other external device to other component(s) of the electronic device 101 or may output commands or data received from other component(s) of the electronic device 101 to the user or other external devices.

The display 160 may include, e.g., a liquid crystal display (LCD), a light emitting diode (LED) display, an organic light emitting diode (OLED) display, or a microelectromechanical systems (MEMS) display, or an electronic paper display. The display 160 may display, e.g., various contents (e.g., text, images, videos, icons, or symbols) to the user. The display 160 may include a touchscreen and may receive, e.g., a touch, gesture, proximity or hovering input using an electronic pen or a body portion of the user. For example, the communication interface 170 may set up communication between the electronic device 101 and an external electronic device (e.g., a first electronic device 102, a second electronic device 104, or a server 106). For example, the communication interface 170 may be connected with the network 162 through wireless or wired communication to communicate with the external electronic device.

The wireless communication may include cellular communication using at least one of, e.g., long-term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM). According to an embodiment of the present disclosure, the wireless communication may include at least one of, e.g., wireless fidelity (Wi-Fi), Bluetooth, Bluetooth low power (BLE), ZigBee, near field communication (NFC), magnetic secure transmission (MST), radio frequency, or body area network (BAN). According to an embodiment of the present disclosure, the wireless communication may include global navigation satellite system (GNSS). The GNSS may be, e.g., global positioning system (GPS), global navigation satellite system (Glonass), Beidou navigation satellite system (hereinafter, “Beidou”) or Galileo, or the European global satellite-based navigation system. Hereinafter, the terms “GPS” and the “GNSS” may be interchangeably used herein. The wired connection may include at least one of, e.g., universal serial bus (USB), high definition multimedia interface (HDMI), recommended standard (RS)-232, power line communication (PLC), or plain old telephone service (POTS). The network 162 may include at least one of telecommunication networks, e.g., a computer network (e.g., local area network (LAN) or wide area network (WAN)), Internet, or a telephone network.

The magnetic sensor 190 may sense a geo-magnetic field around the electronic device 101. The magnetic sensor 190 may include a rotation coil, a fluxgate magnetometer, a quantum magnetometer, an optical pumping magnetometer, or a superconducting quantum interference device (SQUID), but without limited to a specific device as long as the device may sense geo-magnetic fields.

The first and second external electronic devices 102 and 104 each may be a device of the same or a different type from the electronic device 101. According to an embodiment of the present disclosure, all or some of operations executed on the electronic device 101 may be executed on another or multiple other electronic devices (e.g., the electronic devices 102 and 104 or server 106). According to an embodiment of the present disclosure, when the electronic device 101 should perform some function or service automatically or at a request, the electronic device 101, instead of executing the function or service on its own or additionally, may request another device (e.g., electronic devices 102 and 104 or server 106) to perform at least some functions associated therewith. The other electronic device (e.g., electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

According to an embodiment of the present disclosure, the memory 130 may store a first geo-magnetic map including geo-magnetic data for each of a plurality of positions at a first altitude in an area and a second geo-magnetic map including geo-magnetic data for each of a plurality of positions at a second altitude in the area, and the processor 120 may be configured to identify an altitude of the electronic device 101, select one of the first geo-magnetic map and the second geo-magnetic map corresponding to the altitude of the electronic device 101, compare the selected geo-magnetic map with geo-magnetic data sensed by the magnetic sensor, and provide a position of the electronic device 101 using a result of the comparison.

According to an embodiment of the present disclosure, the memory 130 may store association information between the altitude of the electronic device 101 and an event detected by the electronic device 101.

According to an embodiment of the present disclosure, the electronic device 101 may further comprise a motion sensor measuring a motion of the electronic device 101, the association information includes association information between data sensed by the motion sensor and the altitude of the electronic device 101, and the processor 120 may be configured to identify the altitude of the electronic device 101 using the association information and the data sensed by the motion sensor.

According to an embodiment of the present disclosure, the association information may include association information between the altitude of the electronic device 101 and information on an application running on the electronic device 101, and the processor 120 may be configured to identify the altitude of the electronic device 101 using the information on the application running on the electronic device 101.

According to an embodiment of the present disclosure, the electronic device may further comprise an air pressure sensor sensing an air pressure around the electronic device 101, and the processor 120 may be configured to update the identified altitude of the electronic device 101 using data sensed by the air pressure sensor.

According to an embodiment of the present disclosure, the processor 120 may be configured to select a geo-magnetic map corresponding to the updated altitude of the electronic device 101, compare the geo-magnetic map corresponding to the updated altitude of the electronic device 101 with geo-magnetic data sensed by the magnetic sensor at the updated altitude, and provide the position of the electronic device 101 based on a result of the comparison.

According to an embodiment of the present disclosure, the electronic device 101 may further comprise a communication interface 170 receiving the first geo-magnetic map and the second geo-magnetic map from a server.

According to an embodiment of the present disclosure, the processor 120 may be configured to identified, as the position of the electronic device 101, a position mapped to geo-magnetic data having a difference from the geo-magnetic data sensed by the magnetic sensor 190 by less than a threshold on the selected geo-magnetic map.

According to an embodiment of the present disclosure, the processor 120 may be configured to determine, as a position candidate, a first position mapped to the geo-magnetic data having the difference from the geo-magnetic data sensed by the magnetic sensor 190 by less than the threshold on the selected geo-magnetic map at a first time and identify the position of the electronic device 101 at the first time from the position candidate based on whether the position candidate is positioned adjacent to a second position mapped to the geo-magnetic data having the difference from the geo-magnetic data sensed by the magnetic sensor 190 by less than the threshold at a second time.

According to an embodiment of the present disclosure, the processor 120 may be configured to identify an altitude of the electronic device 101, send information on the altitude of the electronic device 101 through the communication interface 170, receive a first geo-magnetic map corresponding to the altitude including geo-magnetic data for each of a plurality of positions in an area corresponding to the altitude of the electronic device 101 through the communication interface 170, compare the received first geo-magnetic map with geo-magnetic data sensed by the magnetic sensor 190, and provide a position of the electronic device 101 using a result of the comparison.

According to an embodiment of the present disclosure, the processor 120 may be configured to detect a change in the altitude of the electronic device 101, send information on the changed altitude through the communication interface 170, receive a second geo-magnetic map corresponding to the changed altitude including geo-magnetic data for each of the plurality of positions in the area corresponding to the changed altitude through the communication interface 170, compare the received second geo-magnetic map with the sensed geo-magnetic data, and provide a position of the electronic device 101 using a result of the comparison.

According to an embodiment of the present disclosure, the electronic device 101 may generate a plurality of per-altitude geo-magnetic maps. In this case, the memory 130 may store a first geo-magnetic map including geo-magnetic data for each of a plurality of positions at a first altitude in an area and a second geo-magnetic map including geo-magnetic data for each of a plurality of positions at a second altitude in the area; and The processor 120 may be configured to generate a third geo-magnetic map including geo-magnetic data for each of a plurality of positions at a third altitude between the first altitude and the second altitude using the first geo-magnetic map and the second geo-magnetic map.

According to an embodiment of the present disclosure, the processor 120 may be configured to detect an entry of another electronic device into the area and send the first geo-magnetic map, the second geo-magnetic map, and the third geo-magnetic map to the other electronic device through the communication interface 170.

According to an embodiment of the present disclosure, the processor 120 may be configured to receive information on an altitude of another electronic device from the other electronic device through the communication interface 170, select a geo-magnetic map corresponding to the altitude of the other electronic device from among the first geo-magnetic map, the second geo-magnetic map, and the third geo-magnetic map, and send the selected geo-magnetic map to the other electronic device through the communication interface 170.

According to an embodiment of the present disclosure, the processor 120 may be configured to apply an interpolation scheme to the first geo-magnetic map and the second geo-magnetic map and generate the third geo-magnetic map using a result of the application of the interpolation scheme.

According to an embodiment of the present disclosure, the processor 120 may be configured to apply the interpolation scheme to geo-magnetic data at a first position of the first geo-magnetic map and geo-magnetic data at a first position of the second geo-magnetic map and obtain geo-magnetic data at a first position of the third geo-magnetic map using a result of the application of the interpolation scheme.

According to an embodiment of the present disclosure, the processor 120 may be configured to obtain the geo-magnetic data at the first position of the third geo-magnetic map using the geo-magnetic data at the second position of the first geo-magnetic map and the result of the application of the interpolation scheme.

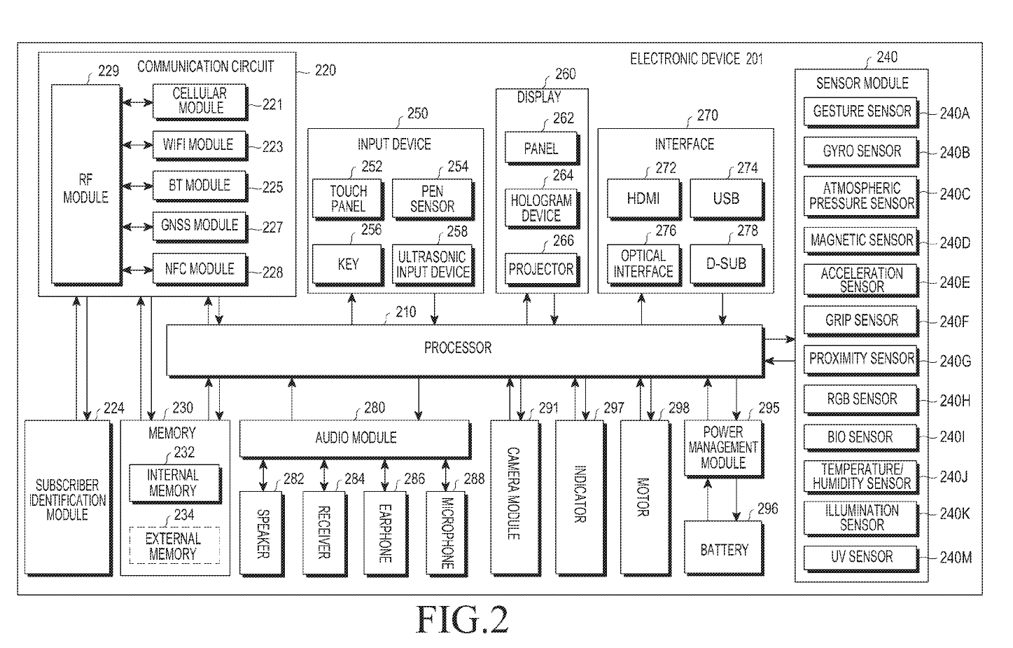

FIG. 2 is a block diagram illustrating an electronic device 201 according to an embodiment of the present disclosure. The electronic device 201 may include the whole or part of the configuration of, e.g., the electronic device 101 shown in FIG. 1. The electronic device 201 may include one or more processors (e.g., application processors (APs)) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210 may control multiple hardware and software components connected to the processor 210 by running, e.g., an operating system or application programs, and the processor 210 may process and compute various data. The processor 210 may be implemented in, e.g., a system on chip (SoC). According to an embodiment of the present disclosure, the processor 210 may further include a graphic processing unit (GPU) and/or an image signal processor. The processor 210 may include at least some (e.g., the cellular module 221) of the components shown in FIG. 2. The processor 210 may load a command or data received from at least one of other components (e.g., a non-volatile memory) on a volatile memory, process the command or data, and store resultant data in the non-volatile memory.

The communication module 220 may have the same or similar configuration to the communication interface 170. The communication module 220 may include, e.g., a cellular module 221, a wireless fidelity (Wi-Fi) module 223, a Bluetooth (BT) module 225, a GNSS module 227, a NFC module 228, and a RF module 229. The cellular module 221 may provide voice call, video call, text, or Internet services through, e.g., a communication network. The cellular module 221 may perform identification or authentication on the electronic device 201 in the communication network using a subscriber identification module 224 (e.g., the SIM card). According to an embodiment of the present disclosure, the cellular module 221 may perform at least some of the functions providable by the processor 210. According to an embodiment of the present disclosure, the cellular module 221 may include a communication processor (CP). According to an embodiment of the present disclosure, at least some (e.g., two or more) of the cellular module 221, the Wi-Fi module 223, the Bluetooth module 225, the GNSS module 227, or the NFC module 228 may be included in a single integrated circuit (IC) or an IC package. The RF module 229 may communicate data, e.g., communication signals (e.g., RF signals). The RF module 229 may include, e.g., a transceiver, a power amp module (PAM), a frequency filter, a low noise amplifier (LNA), or an antenna. According to an embodiment of the present disclosure, at least one of the cellular module 221, the Wi-Fi module 223, the Bluetooth module 225, the GNSS module 227, or the NFC module 228 may communicate RF signals through a separate RF module. The subscription identification module 224 may include, e.g., a card including a subscriber identification module or an embedded SIM, and may contain unique identification information (e.g., an integrated circuit card identifier (ICCID) or subscriber information (e.g., an international mobile subscriber identity (IMSI)).

The memory 230 (e.g., the memory 130) may include, e.g., an internal memory 232 or an external memory 234. The internal memory 232 may include at least one of, e.g., a volatile memory (e.g., a dynamic RAM (DRAM), a static RAM (SRAM), a synchronous dynamic RAM (SDRAM), etc.) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD). The external memory 234 may include a flash drive, e.g., a compact flash (CF) memory, a secure digital (SD) memory, a micro-SD memory, a min-SD memory, an extreme digital (xD) memory, a multi-media card (MMC), or a Memory Stick™. The external memory 234 may be functionally or physically connected with the electronic device 201 via various interfaces.

For example, the sensor module 240 may measure a physical quantity or detect an operational state of the electronic device 201, and the sensor module 240 may convert the measured or detected information into an electrical signal. The sensor module 240 may include at least one of, e.g., a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., an Red-Green-Blue (RGB) sensor, a bio sensor 240I, a temperature/humidity sensor 240J, an illumination sensor 240K, or an Ultra Violet (UV) sensor 240M. Additionally or alternatively, the sensing module 240 may include, e.g., an e-nose sensor, an electromyography (EMG) sensor, an electroencephalogram (EEG) sensor, an electrocardiogram (ECG) sensor, an infrared (IR) sensor, an iris sensor, or a finger print sensor. The sensor module 240 may further include a control circuit for controlling at least one or more of the sensors included in the sensing module. According to an embodiment of the present disclosure, the electronic device 201 may further include a processor configured to control the sensor module 240 as part of the processor 210 or separately from the processor 210, and the electronic device 10 may control the sensor module 240 while the processor 11 is in a sleep mode.

The input unit 250 may include, e.g., a touch panel 252, a (digital) pen sensor 254, a key 256, or an ultrasonic input device 258. The touch panel 252 may use at least one of capacitive, resistive, infrared, or ultrasonic methods. The touch panel 252 may further include a control circuit. The touch panel 252 may further include a tactile layer and may provide a user with a tactile reaction. The (digital) pen sensor 254 may include, e.g., a part of a touch panel or a separate sheet for recognition. The key 256 may include e.g., a physical button, optical key or key pad. The ultrasonic input device 258 may sense an ultrasonic wave generated from an input tool through a microphone (e.g., the microphone 288) to identify data corresponding to the sensed ultrasonic wave.

The display 260 (e.g., the display 160) may include a panel 262, a hologram device 264, a projector 266, and/or a control circuit for controlling the same. The panel 262 may be implemented to be flexible, transparent, or wearable. The panel 262, together with the touch panel 252, may be configured in one or more modules. According to an embodiment of the present disclosure, the panel 262 may include a pressure sensor (or pose sensor) that may measure the strength of a pressure by the user's touch. The pressure sensor may be implemented in a single body with the touch panel 252 or may be implemented in one or more sensors separate from the touch panel 252. The hologram device 264 may make three dimensional (3D) images (holograms) in the air by using light interference. The projector 266 may display an image by projecting light onto a screen. The screen may be, for example, located inside or outside of the electronic device 201. The interface 270 may include e.g., a High Definition Multimedia Interface (HDMI) 272, a USB 274, an optical interface 276, or a D-subminiature (D-sub) 278. The interface 270 may be included in e.g., the communication interface 170 shown in FIG. 1. Additionally or alternatively, the interface 270 may include a Mobile High-definition Link (MHL) interface, a secure digital (SD) card/multimedia card (MMC) interface, or infrared data association (IrDA) standard interface.

The audio module 280 may convert, e.g., a sound signal into an electrical signal and vice versa. At least a part of the audio module 280 may be included in e.g., the input/output interface 145 as shown in FIG. 1. The audio module 280 may process sound information input or output through e.g., a speaker 282, a receiver 284, an earphone 286, or a microphone 288. For example, the camera module 291 may be a device for capturing still images and videos, and may include, according to an embodiment of the present disclosure, one or more image sensors (e.g., front and back sensors), a lens, an image signal processor (ISP), or a flash such as an LED or xenon lamp. The power manager module 295 may manage power of the electronic device 201, for example. According to an embodiment of the present disclosure, the power manager module 295 may include a power management Integrated circuit (PMIC), a charger IC, or a battery or fuel gauge. The PMIC may have a wired and/or wireless recharging scheme. The wireless charging scheme may include e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 296, a voltage, a current, or a temperature while the battery 296 is being charged. The battery 296 may include, e.g., a rechargeable battery or a solar battery.

The indicator 297 may indicate a particular state of the electronic device 201 or a part (e.g., the processor 210) of the electronic device, including e.g., a booting state, a message state, or recharging state. The motor 298 may convert an electric signal to a mechanical vibration and may generate a vibrational or haptic effect. The electronic device 201 may include a mobile TV supporting device (e.g., a GPU) that may process media data as per, e.g., digital multimedia broadcasting (DMB), digital video broadcasting (DVB), or mediaFlo™ standards. Each of the aforementioned components of the electronic device may include one or more parts, and a name of the part may vary with a type of the electronic device. According to various embodiments, the electronic device (e.g., the electronic device 201) may exclude some elements or include more elements, or some of the elements may be combined into a single entity that may perform the same function as by the elements before combined.

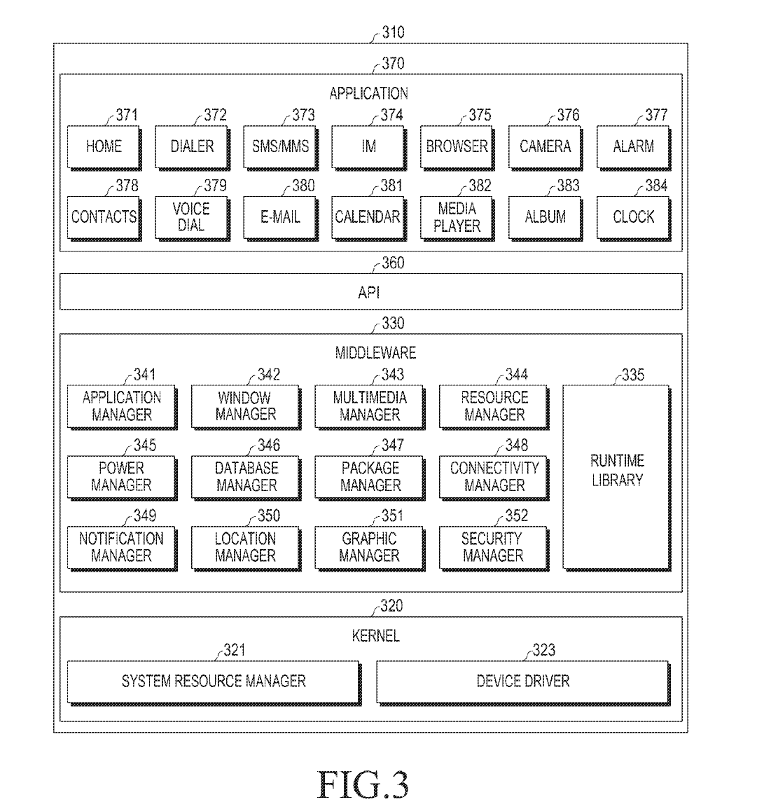

FIG. 3 is a block diagram illustrating a program module according to an embodiment of the present disclosure; According to an embodiment of the present disclosure, the program module 310 (e.g., the program 140) may include an operating system (OS) controlling resources related to the electronic device (e.g., the electronic device 101) and/or various applications (e.g., the application processor 147) driven on the operating system. The operating system may include, e.g., Android™, iOS™, Windows™ Symbian™, Tizen™, or Bada™. Referring to FIG. 3, the program module 310 may include a kernel 320 (e.g., the kernel 141), middleware 330 (e.g., the middleware 143), an API 360 (e.g., the API 145), and/or an application 370 (e.g., the application program 147). At least a part of the program module 310 may be preloaded on the electronic device or may be downloaded from an external electronic device (e.g., the electronic devices 102 and 104 or server 106).

The kernel 320 may include, e.g., a system resource manager 321 or a device driver 323. The system resource manager 321 may perform control, allocation, or recovery of system resources. According to an embodiment of the present disclosure, the system resource manager 321 may include a process managing unit, a memory managing unit, or a file system managing unit. The device driver 323 may include, e.g., a display driver, a camera driver, a Bluetooth driver, a shared memory driver, a USB driver, a keypad driver, a Wi-Fi driver, an audio driver, or an inter-process communication (IPC) driver. The middleware 330 may provide various functions to the application 370 through the API 360 so that the application 370 may use limited system resources in the electronic device or provide functions jointly required by applications 370. According to an embodiment of the present disclosure, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module used by a compiler in order to add a new function through a programming language while, e.g., the application 370 is being executed. The runtime library 335 may perform input/output management, memory management, or arithmetic function processing. The application manager 341 may manage the life cycle of, e.g., the applications 370. The window manager 342 may manage GUI resources used on the screen. The multimedia manager 343 may grasp formats necessary to play media files and use a codec appropriate for a format to perform encoding or decoding on media files. The resource manager 344 may manage the source code or memory space of the application 370. The power manager 345 may manage, e.g., the battery capability or power and provide power information necessary for the operation of the electronic device. According to an embodiment of the present disclosure, the power manager 345 may interwork with a basic input/output system (BIOS). The database manager 346 may generate, search, or vary a database to be used in the applications 370. The package manager 347 may manage installation or update of an application that is distributed in the form of a package file.

The connectivity manager 348 may manage, e.g., wireless connectivity. The notification manager 349 may provide an event, e.g., arrival message, appointment, or proximity alert, to the user. The location manager 350 may manage, e.g., locational information on the electronic device. The graphic manager 351 may manage, e.g., graphic effects to be offered to the user and their related user interface. The security manager 352 may provide system security or user authentication, for example. According to an embodiment of the present disclosure, the middleware 330 may include a telephony manager for managing the voice or video call function of the electronic device or a middleware module able to form a combination of the functions of the above-described elements. According to an embodiment of the present disclosure, the middleware 330 may provide a module specified according to the type of the operating system. The middleware 330 may dynamically omit some existing components or add new components. The API 360 may be a set of, e.g., API programming functions and may have different configurations depending on operating systems. For example, in the case of Android or iOS, one API set may be provided per platform, and in the case of Tizen, two or more API sets may be offered per platform.

The application 370 may include an application that may provide, e.g., a home 371, a dialer 372, an SMS/MMS 373, an instant message (IM) 374, a browser 375, a camera 376, an alarm 377, a contact 378, a voice dial 379, an email 380, a calendar 381, a media player 382, an album 383, or a clock or watch 384, a health-care (e.g., measuring the degree of workout or blood sugar), or provision of environmental information (e.g., provision of air pressure, moisture, or temperature information). According to an embodiment of the present disclosure, the application 370 may include an information exchanging application supporting information exchange between the electronic device and an external electronic device. Examples of the information exchange application may include, but is not limited to, a notification relay application for transferring specific information to the external electronic device, or a device management application for managing the external electronic device. For example, the notification relay application may transfer notification information generated by other application of the electronic device to the external electronic device or receive notification information from the external electronic device and provide the received notification information to the user. For example, the device management application may install, delete, or update a function (e.g., turn-on/turn-off the external electronic device (or some elements) or adjusting the brightness (or resolution) of the display) of the external electronic device communicating with the electronic device or an application operating on the external electronic device. According to an embodiment of the present disclosure, the application 370 may include an application (e.g., a health-care application of a mobile medical device) designated according to an attribute of the external electronic device. According to an embodiment of the present disclosure, the application 370 may include an application received from the external electronic device. At least a portion of the program module 310 may be implemented (e.g., executed) in software, firmware, hardware (e.g., the processor 210), or a combination of at least two or more thereof and may include a module, program, routine, command set, or process for performing one or more functions.

As used herein, the term “module” includes a unit configured in hardware, software, or firmware and may be interchangeably used with other term, e.g., a logic, logic block, part, or circuit. The module may be a single integral part or a minimum unit or part of performing one or more functions. The module may be implemented mechanically or electronically and may include, e.g., an application-specific integrated circuit (ASIC) chip, field-programmable gate arrays (FPGAs), or programmable logic device, that has been known or to be developed in the future as performing some operations. According to an embodiment of the present disclosure, at least a part of the device (e.g., modules or their functions) or method (e.g., operations) may be implemented as instructions stored in a computer-readable storage medium (e.g., the memory 130), e.g., in the form of a program module. The instructions, when executed by a processor (e.g., the processor 120), may enable the processor to carry out a corresponding function. The computer-readable medium may include, e.g., a hard disk, a floppy disc, a magnetic medium (e.g., magnetic tape), an optical recording medium (e.g., CD-ROM, DVD, magnetic-optical medium (e.g., floptical disk), or an embedded memory. The instruction may include a code created by a compiler or a code executable by an interpreter. Modules or programming modules in accordance with various embodiments of the present disclosure may include at least one or more of the aforementioned components, omit some of them, or further include other additional components. Operations performed by modules, programming modules or other components in accordance with various embodiments of the present disclosure may be carried out sequentially, in parallel, repeatedly or heuristically, or at least some operations may be executed in a different order or omitted or other operations may be added.

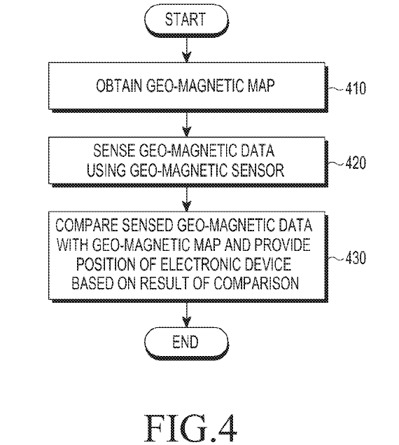

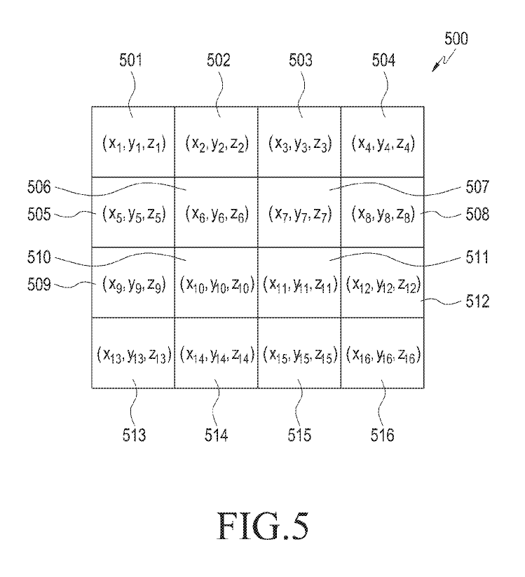

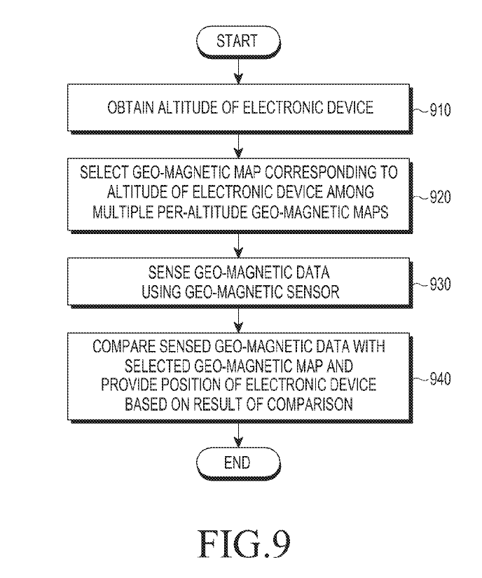

FIG. 4 is a flowchart illustrating a method for operating an electronic device according to an embodiment of the present disclosure. The embodiment shown in FIG. 4 is described in greater detail with reference to FIG. 5. FIG. 5 is a concept view illustrating a 2D geo-magnetic map according to an embodiment of the present disclosure. With reference to FIG. 4, a method for determining a position using a geo-magnetic map at one altitude is described. A method for determining a position using a plurality of per-altitude geo-magnetic maps is described below in detail with reference to FIG. 9.

In operation 410, the electronic device 101 may obtain a geo-magnetic map. For example, when the electronic device 101 enters a particular area, the electronic device 101 may obtain a geo-magnetic map for the particular area from another electronic device (e.g., a server or control point) in charge of the particular area. In this case, the electronic device 101 may obtain a geo-magnetic map from an electronic device positioned relatively in a short distance based on, e.g., short-range communication.

Or, the electronic device 101 may obtain a geo-magnetic map for the particular area from an electronic device positioned remotely but not in the particular area. For example, when the electronic device 101 is determined to enter from an outdoor place to an indoor place, the electronic device 101 may obtain a geo-magnetic map corresponding to the indoor place from another electronic device. That is, the electronic device 101 may obtain a geo-magnetic map for a particular area from an electronic device positioned in or outside the particular area, and obtaining a geo-magnetic map by the electronic device 101 is not limited to a particular configuration.

FIG. 5 is a concept view illustrating a geo-magnetic map according to an embodiment of the present disclosure. Referring to FIG. 5, the geo-magnetic map 500 may include per-2D position geo-magnetic data for a particular area. For example, as shown in FIG. 5, the geo-magnetic map 500 may have the particular area split into sixteen positions 501 to 516 respectively corresponding to geo-magnetic data. For example, the geo-magnetic data at a first position 501 may be (x1,y1,z1). The geo-magnetic data may be a 3D vector and is thus represented as if it has three components. Meanwhile, it will easily be appreciated by one of ordinary skill in the art that representing a vector value of geo-magnetic data in the form of orthogonal coordinates is merely an example, and is not limited to a particular coordinate system. As shown in FIG. 5, geo-magnetic data (x1,y1,z1) at the first position 501 may differ from geo-magnetic data (x3,y3,z3) at a third position 503. This may be attributed to a difference in geography between a structure disposed near the first position 501 and a structure disposed near the third position 503. Geo-magnetic data may be a geo-magnetic field that may be influenced by a structure including a metal around, and thus, geo-magnetic data may differ position to position. Meanwhile, the geo-magnetic map 500 may previously be created and stored in the electronic device 101 or another electronic device.

In operation 420, the electronic device 101 may obtain geo-magnetic data using a magnetic sensor. In operation 430, the electronic device 101 may compare sensed geo-magnetic data with the geo-magnetic map and provide the position of the electronic device based on the result of comparison. For example, it is assumed that the geo-magnetic data obtained by the electronic device 101 is (x5,y5,z5). The electronic device 101 may compare geo-magnetic data (x5,y5,z5) obtained with the geo-magnetic map 500 as shown in FIG. 5 and determine that the position of the electronic device corresponding to the obtained geo-magnetic data is a fifth position 505. Thus, the electronic device 101 may provide the current position being the fifth position 505 or provide a location-based service corresponding to the fifth position 505. That is, the electronic device 101 may determine that the position mapped to the geo-magnetic data having a difference of less than a threshold from the obtained geo-magnetic data of the geo-magnetic map is the position of the electronic device 101. According to an embodiment of the present disclosure, the electronic device 101 may provide various location-based services, such as indoor navigation, advertisement corresponding to a particular position, and AR service.

As described above, according to an embodiment of the present disclosure, the electronic device 101 may compare geo-magnetic data obtained through a magnetic sensor with a geo-magnetic map previously created and determine a position using the result of comparison. For example, the electronic device 101 may provide various location-based services corresponding to particular positions, such as 506, 507, 508, 509, 510, and 513, 514, and 515, as in FIG. 5.

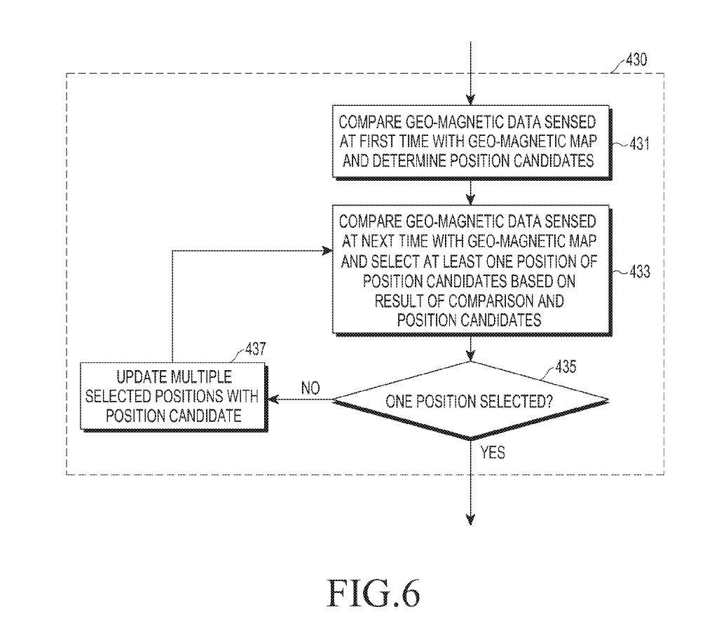

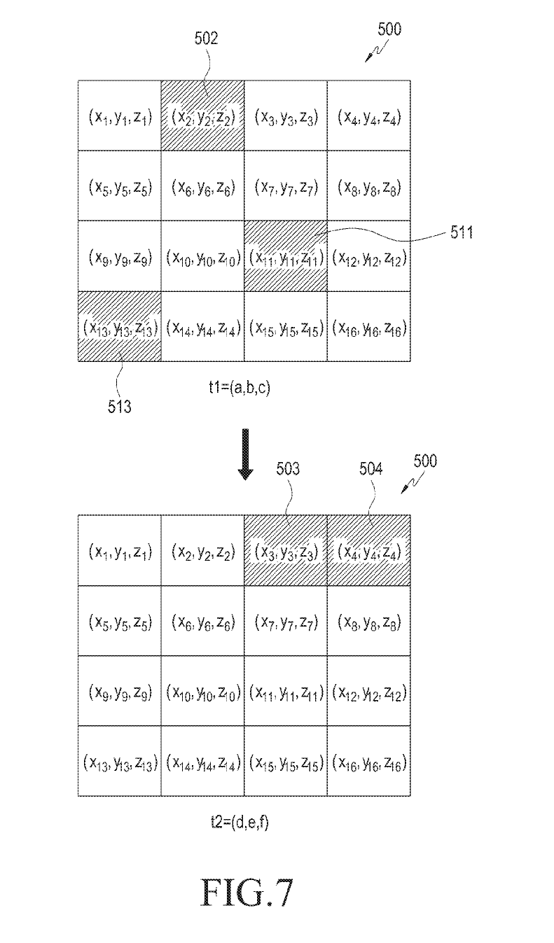

FIG. 6 is a flowchart illustrating a method for controlling an electronic device according to an embodiment of the present disclosure. With reference to FIG. 6, an embodiment of a positioning method where there are a plurality of position candidates as a result of comparison between a geo-magnetic map and geo-magnetic data obtained is described, and this is described in further detail with reference to FIG. 7. FIG. 7 is a concept view illustrating a geo-magnetic map according to an embodiment of the present disclosure.

In operation 431, the electronic device 101 may compare geo-magnetic data sensed at a first time with a geo-magnetic map and determine position candidates. For example, as shown in FIG. 7, it is assumed that geo-magnetic data obtained by the electronic device 101 at a first time t1 is (a,b,c). The electronic device 101 may compare the obtained geo-magnetic data (a,b,c) with a geo-magnetic map 500 and determine that positions 502, 511, and 513 with a similarity less than a threshold are position candidates. For example, a difference between (a,b,c) and (x2,y2,z2) may be less than the threshold.

In operation 433, the electronic device 101 may compare geo-magnetic data sensed at a next time with the geo-magnetic map and select at least one position of the positions based on the result of comparison and position candidates. For example, as shown in FIG. 7, it is assumed that geo-magnetic data obtained by the electronic device 101 at a second time t2 is (d,e,f). The electronic device 101 may compare the obtained geo-magnetic data (d,e,f) with the geo-magnetic map 500 and identify positions 503 and 504 with a similarity less than a threshold. That is, the identified positions 503 and 504 may be a result of comparison between the geo-magnetic data sensed at the next time with the geo-magnetic map. The electronic device 101 may compare existing position candidates 502, 511, and 516 determined with the identified positions 503 and 504 which are a result of comparison. The electronic device 101 may determine that, among the position candidates 502, 511, and 516, a position continuous to the identified positions 503 and 504 is a second position 502. Thus, the electronic device 101 may determine that the position of the electronic device 101 at the first time t1 is the second position 502, and the position of the electronic device 101 at the second time t2 is a third position 503. As set forth above, the electronic device 101 may determine a position by comparing per-time geo-magnetic data with the geo-magnetic map while tracing geo-magnetic data as times go by.

In operation 435, the electronic device 101 may determine whether the number of positions selected is one. When multiple positions are still selected, the electronic device 101, in operation 437, may continue to trace geo-magnetic data while updating the plurality of selected positions as position candidates.

As described above, according to an embodiment of the present disclosure, the electronic device 101, even when determining that there are a plurality of positions as a result of comparison between sensed geo-magnetic data and the geo-magnetic map, may trace and sense geo-magnetic data and may determine a position by comparing the geo-magnetic map with geo-magnetic data obtained per time.

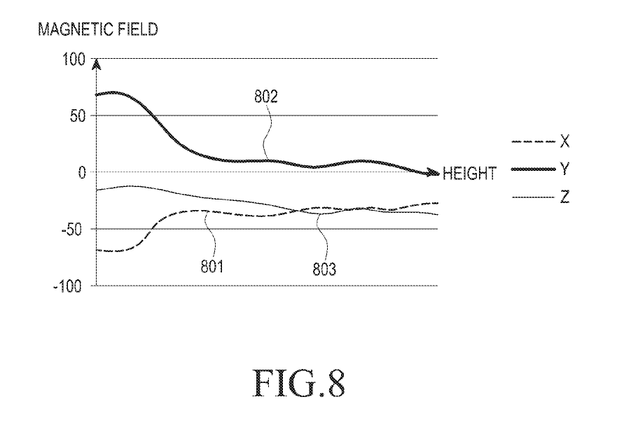

Meanwhile, there has been described a positioning method using a geo-magnetic map for one altitude in the embodiments described in connection with FIGS. 4 to 7. However, even at one position, geo-magnetic characteristics may vary depending on altitudes. FIG. 8 is a graph illustrating a variation in a geo-magnetic characteristic depending on altitudes at one position.

As shown in FIG. 8, an x-axis geo-magnetic characteristic 801, y-axis geo-magnetic characteristic 802, and z-axis geo-magnetic characteristic 803, each, may be varied per altitude at one position. For example, when the geo-magnetic map 500 shown in FIG. 5 is created using geo-magnetic data measured at an altitude H1, the geo-magnetic data at altitude H1 of the first position 501 may be (x1,y1,z1), but geo-magnetic data at an altitude of the position 501, other than H1, may be a value different from (x1,y1,z1). Thus, when the electronic device 101 determines a position by comparing geo-magnetic data sensed at, e.g., altitude H2, with a geo-magnetic map created at altitude H1, the determined position may be inaccurate.

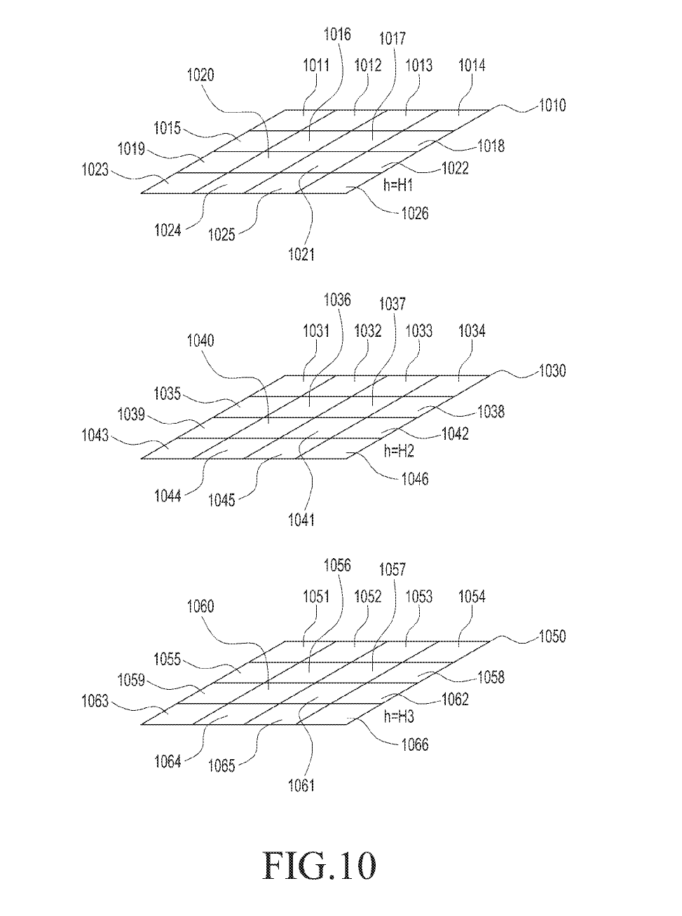

FIG. 9 is a flowchart illustrating an operation of an electronic device according to an embodiment of the present disclosure. An embodiment is described in detail with reference to FIG. 9 along with FIG. 10. FIG. 10 is a concept view illustrating a plurality of per-altitude geo-magnetic maps, i.e., 3D geo-magnetic maps, according to an embodiment of the present disclosure.

In operation 910, the electronic device 101 may obtain an altitude of the electronic device 101. The electronic device 101 may determine the altitude by detecting occurrence of an event corresponding to the altitude. Or, the electronic device 101 may obtain the altitude of the electronic device 101 using sensing data obtained from various sensors, e.g., an air pressure sensor.

In operation 920, the electronic device 101 may select a geo-magnetic map corresponding to the altitude of the electronic device from among a plurality of per-altitude geo-magnetic maps. The electronic device 101 is assumed to have previously obtained a plurality of per-altitude geo-magnetic maps, and a configuration in which the electronic device 101 previously obtains a plurality of per-altitude geo-magnetic maps is described below in further detail. For example, in operation 910, the electronic device 101 may determine that the altitude of the electronic device 101 is H2. The electronic device 101 is also assumed to have stored a 2D geo-magnetic map 1010 when the altitude is H1, a 2D geo-magnetic map 1030 when the altitude is H2, and a 2D geo-magnetic map 1050 when the altitude is H3. The electronic device 101 may select the geo-magnetic map 1030 corresponding to the altitude H2 of the electronic device 101 from among the plurality of per-altitude geo-magnetic maps 1010, 1030, and 1050.

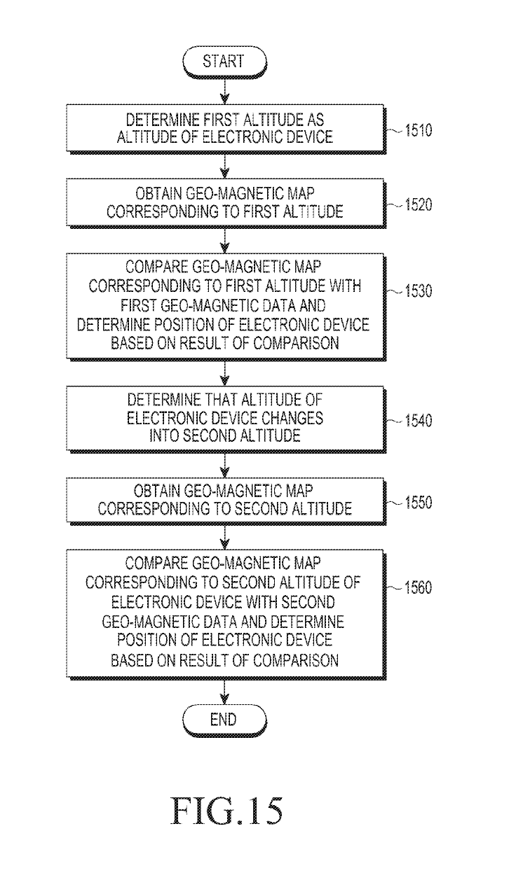

In operation 930, the electronic device 101 may sense geo-magnetic data using a magnetic sensor. In operation 940, the electronic device 101 may compare sensed geo-magnetic data with the selected geo-magnetic map and provide the position of the electronic device based on the result of comparison. For example, the 2D geo-magnetic map 1010 when the altitude is H1 in the 3D geo-magnetic map may be split into 16 positions 1011 to 1026, and geo-magnetic data for each of the 16 positions 1011 to 1026 may be included. The 2D geo-magnetic map 1030 when the altitude is H2 may also be split into 16 positions 1031 to 1046, and geo-magnetic data for each of the 16 positions 1031 to 1046 may be included. The 2D geo-magnetic map 1050 when the altitude is H3 may also be split into 16 positions 1051 to 1066, and geo-magnetic data for each of the 16 positions 1051 to 1066 may be included. Meanwhile, as described in connection with FIG. 8, geo-magnetic characteristics may differ altitude to altitude even at the same position. Thus, the geo-magnetic data at the first position 1011 when the altitude is H1, the geo-magnetic data at the first position 1031 when the altitude is H2, and the geo-magnetic data at the first position 1051 when the altitude is H3 may differ from each other. Therefore, a geo-magnetic map for a particular altitude is required to be selected. According to an embodiment of the present disclosure, the electronic device 101 may select one of a plurality of per-altitude geo-magnetic maps based on an altitude of the electronic device 101 and determine a more precise position by comparing the selected geo-magnetic map with a sensed geo-magnetic field. A process for the electronic device 101 to determine a position using the selected geo-magnetic map and sensed geo-magnetic data has been described above in connection with FIGS. 4 and 5, and no further detailed description thereof is given below. Further, the electronic device 101 may determine a plurality of position candidates from the selected geo-magnetic map, and in this case, as described above in connection with FIGS. 6 and 7, the electronic device 101 may trace and sense geo-magnetic data and compare a selected geo-magnetic map with data sensed over time to determine a position. Meanwhile, the altitude of the electronic device 101 may vary over time, and in this case, the electronic device 101 may change geo-magnetic maps to be compared depending on the variation in altitude. A configuration for the electronic device 101 to change geo-magnetic maps to be compared is described in greater detail with reference to FIG. 15.

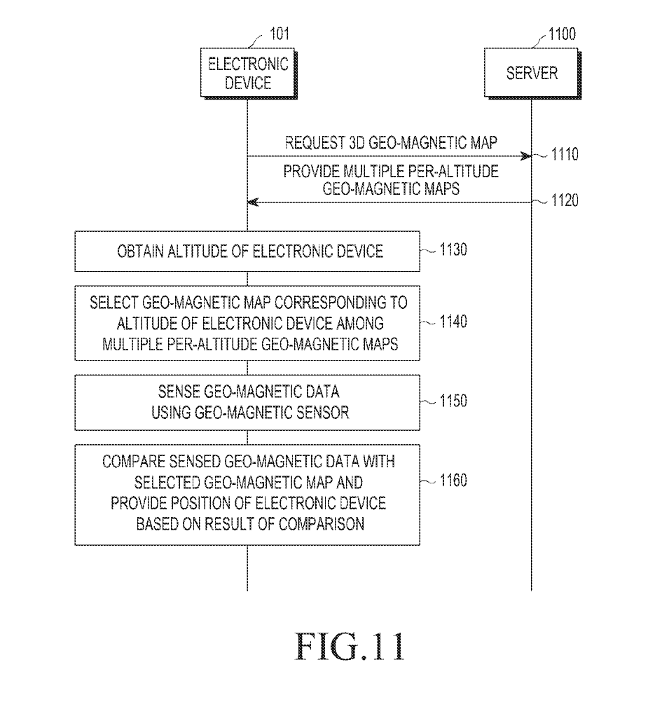

FIG. 11 is a flowchart illustrating an example of obtaining a 3D geo-magnetic map by an electronic device according to an embodiment of the present disclosure.

In operation 1110, the electronic device 101 may send a request for a 3D geo-magnetic map to a server 1100. According to an embodiment of the present disclosure, when the electronic device 101 enters a particular area, the electronic device 101 may send a request for a 3D geo-magnetic map to the server 1100 storing the 3D geo-magnetic map for the particular area. As set forth above, the server 1100 may be disposed in or remotely outside the particular area which the electronic device 101 enters. In operation 1120, the server 1100 may provide a plurality of per-altitude geo-magnetic maps, i.e., a 3D geo-magnetic map, to the electronic device 101 in response to the request. According to an embodiment of the present disclosure, the server 1100 may be configured to provide the 3D geo-magnetic map immediately when discovering the electronic device 101 even without a request from the electronic device 101. In this case, the electronic device 101 may receive the 3D geo-magnetic map immediately when entering the particular area. In other words, the electronic device 101 may previously store per-altitude geo-magnetic maps for the particular area.

In operation 1130, the electronic device 101 may obtain an altitude of the electronic device 101. As described above, the electronic device 101 may obtain the altitude of the electronic device 101 by detecting an event from which the altitude may be identified or using sensing data from various sensors. In operation 1140, the electronic device 101 may select one geo-magnetic map corresponding to the altitude of the electronic device 101 among a plurality of per-altitude geo-magnetic maps. In operation 1150, the electronic device 101 may sense geo-magnetic data using a magnetic sensor. In operation 1160, the electronic device 101 may compare sensed geo-magnetic data with the selected geo-magnetic map and provide a position of the electronic device 101 based on the result of comparison.

As described above, the electronic device 101 may previously store a plurality of per-altitude geo-magnetic maps, select a geo-magnetic map according to the determined altitude, and compare the selected geo-magnetic map with the sensed geo-magnetic data to determine the position of the electronic device 101.

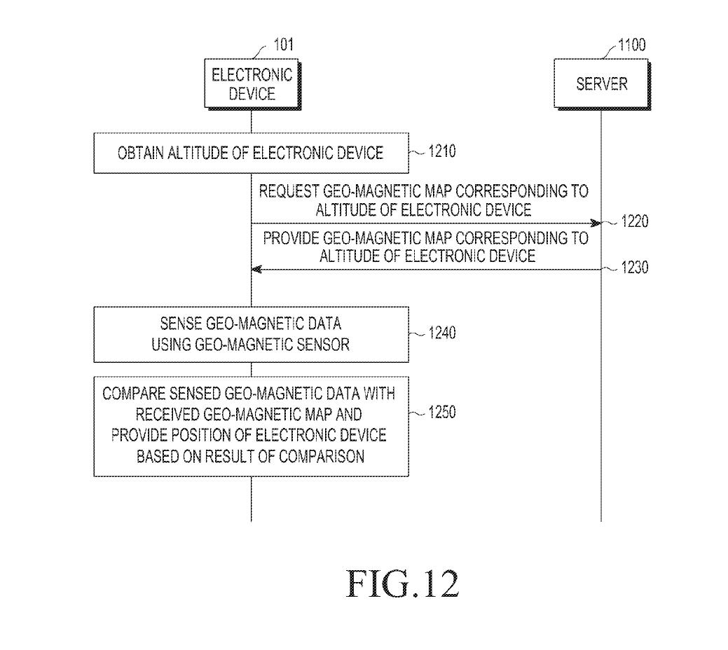

FIG. 12 is a flowchart illustrating an example of obtaining a geo-magnetic map according to an embodiment of the present disclosure.

In operation 1210, the electronic device 101 may obtain an altitude of the electronic device 101. In operation 1220, the electronic device 101 may send a request for a geo-magnetic map corresponding to the altitude of the electronic device 101 to the server 1100. The server 1100 may previously store a plurality of per-altitude geo-magnetic maps for a particular area. In operation 1230, the server 1100 may select a geo-magnetic map corresponding to the altitude of the electronic device 101 among the plurality of per-altitude geo-magnetic maps and provide the selected geo-magnetic map to the electronic device 101. In other words, the electronic device 101 may be configured to receive the geo-magnetic map corresponding to the altitude, rather than previously storing and storing all the geo-magnetic maps for the particular area.

In operation 1240, the electronic device 101 may sense geo-magnetic data using a magnetic sensor. In operation 1250, the electronic device 101 may compare sensed geo-magnetic data with the received geo-magnetic map and provide a position of the electronic device 101 based on the result of comparison.

As described above, the electronic device 101 may receive a geo-magnetic map corresponding to the altitude of the electronic device 101 among the plurality of per-altitude geo-magnetic maps and compare the received geo-magnetic map with the sensed geo-magnetic data to determine the position of the electronic device 101.

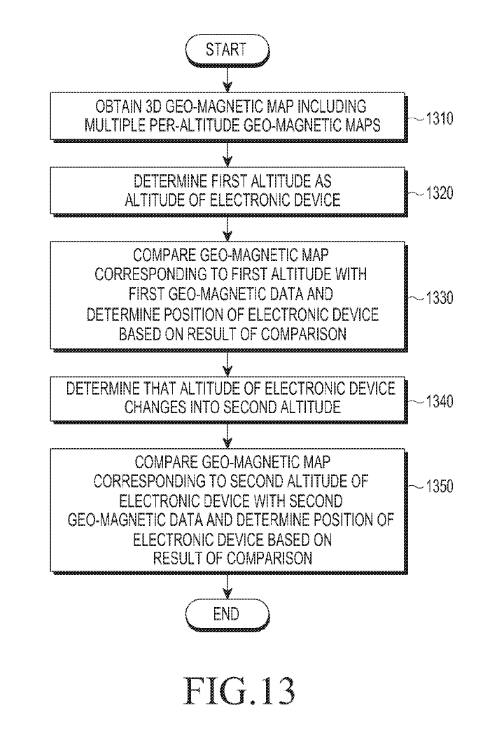

FIG. 13 is a flowchart illustrating a method for operating an electronic device when the altitude of the electronic device varies in a positioning process.

In operation 1310, the electronic device 101 may obtain a 3D geo-magnetic map including a plurality of per-altitude geo-magnetic maps for a particular area. That is, similar to the embodiment described in connection with FIG. 11, the electronic device 101 may previously receive and store a plurality of per-altitude geo-magnetic maps for a particular area.

In operation 1320, the electronic device 101 may determine that the altitude of the electronic device is a first altitude. In operation 1330, the electronic device 101 may compare a geo-magnetic map corresponding to the first altitude with first geo-magnetic data and determine the position of the electronic device 101 based on a result of the comparison. Here, the first geo-magnetic data may mean geo-magnetic data sensed by the electronic device 101 at the first altitude. That is, the electronic device 101 may compare the geo-magnetic data sensed at the first altitude with the geo-magnetic map corresponding to the first altitude and determine the position of the electronic device 101 based on the result of comparison.

In operation 1340, the electronic device 101 may determine that the altitude of the electronic device 101 is changed from the first altitude to a second altitude. As described above, the electronic device 101 may determine the change of altitude by detecting an event indicating an altitude or using sensing data from various sensors. In operation 1350, the electronic device 101 may compare a geo-magnetic map corresponding to the second altitude with second geo-magnetic data and determine the position of the electronic device 101 based on a result of the comparison. Here, the second geo-magnetic data may mean geo-magnetic data sensed by the electronic device 101 at the second altitude. That is, the electronic device 101 may compare the geo-magnetic data sensed at the second altitude with the geo-magnetic map corresponding to the second altitude and determine the position of the electronic device 101 based on the result of comparison.

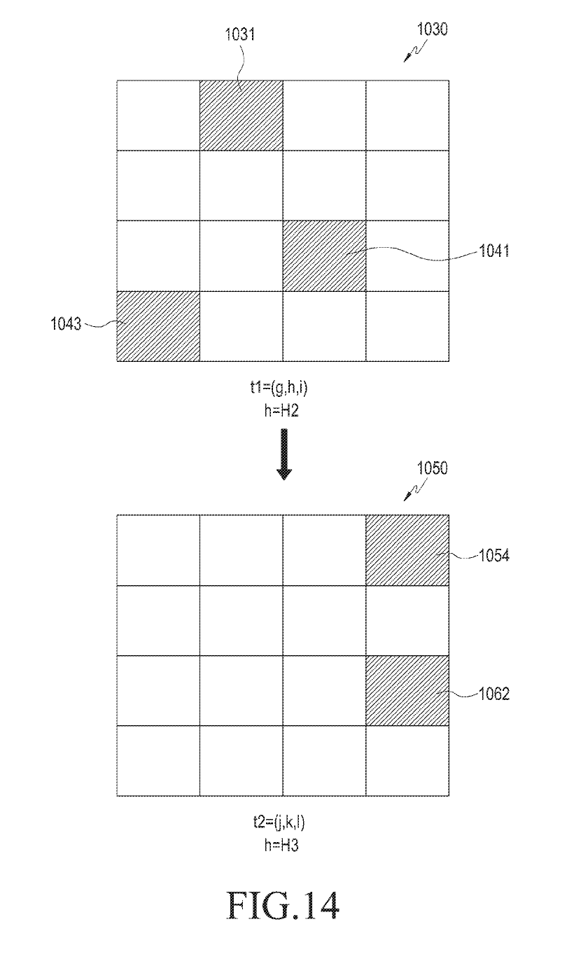

FIG. 14 is a concept view illustrating a per-altitude geo-magnetic map according to an embodiment of the present disclosure. For example, the electronic device 101 may obtain first geo-magnetic data (g,h,i) at the first altitude H2 at a first time t1. In this case, the electronic device 101 may select the geo-magnetic map 1030 corresponding to the first altitude H2 among a plurality of per-altitude geo-magnetic maps. The electronic device 101 may compare the selected geo-magnetic map 1030 with the sensed first geo-magnetic data (g,h,i) and determine position candidates 1032, 1041, and 1043. Since the electronic device 101 failed to determine one position, the electronic device 101 may trace and sense geo-magnetic data as described above. For example, the electronic device 101 may obtain second geo-magnetic data (j,k,l) at a second time t2. Besides, the electronic device 101 may determine that the altitude of the electronic device 101 at the second time t2 is changed to the second altitude H3. In this case, the electronic device 101 may change a geo-magnetic map to be compared from the geo-magnetic map 1030 corresponding to the first altitude H2 to the geo-magnetic map 1050 corresponding to the second altitude H3. The electronic device 101 may compare the selected geo-magnetic map 1050 with the second geo-magnetic data (j,k,l) and determine positions 1054 and 1062 based on the result of comparison. The electronic device 101 determines that the position candidates at the first time t1 are the second position 1032, the eleventh position 1041, and the thirteenth position 1043 and that the position candidates at the second time t2 are the fourth position 1054 and the twelfth position 1062. The electronic device 101 may determine position candidates adjacent to each other from among the position candidates at the first time t1 and position candidates at the second time t2. For example, the electronic device 101 may determine that the eleventh position 1041 at the first time t1 is adjacent to the twelfth position 1062 at the second time t2 and that none of the other position candidates are adjacent to each other. The electronic device 101 may determine that the eleventh position 1041 and the twelfth position 1062, which are position candidates determined to be adjacent to each other over time, are positions of the electronic device 101. In other words, the electronic device 101 may determine that the position at the first time t1 is the eleventh position 1041 and the position at the second time t2 is the twelfth position 1062. Meanwhile, when there are a plurality of position candidates at the second time, the electronic device 101 may continue to repeat the process of tracing and sensing geo-magnetic data and comparing with the geo-magnetic map to exclude position candidates. Meanwhile, the configuration in which the electronic device 101 determines that only position candidates adjacent to each other are positions of the electronic device as shown in FIG. 14 is merely an example, and the reference from which the electronic device 101 determines adjacent position candidates may be subject to variation. For example, when the electronic device 101 sets three units as a reference for determining position candidates, the electronic device 101 may determine its position while excluding position candidates disposed exceeding four units over time.

FIG. 15 is a flowchart illustrating a method for operating an electronic device according to an embodiment of the present disclosure.

In operation 1510, the electronic device 101 may determine that the altitude of the electronic device 101 is a first altitude. In operation 1520, the electronic device 101 may obtain a geo-magnetic map corresponding to the first altitude. That is, in contrast to the embodiment of FIG. 13 in which the electronic device 101 previously stores all of the plurality of per-altitude geo-magnetic maps, the electronic device 101 may obtain a geo-magnetic map corresponding to the current altitude from, e.g., a server. The electronic device 101 may send a signal including the current altitude to, e.g., a server, and in response thereto, the server may provide a geo-magnetic map corresponding to the current altitude of the electronic device 101.

In operation 1530, the electronic device 101 may compare a geo-magnetic map corresponding to the first altitude with first geo-magnetic data and determine the position of the electronic device 101 based on a result of the comparison. Here, the first geo-magnetic data may be geo-magnetic data sensed by the electronic device 101 at the first altitude.

In operation 1540, the electronic device 101 may determine that the altitude of the electronic device 101 is changed from the first altitude to a second altitude. For example, the electronic device 101 may determine that the current altitude is the second altitude. In operation 1550, the electronic device 101 may obtain a geo-magnetic map corresponding to the second altitude. For example, the electronic device 101 may send a signal indicating that the current altitude is the second altitude to, e.g., a server, and in response thereto, the server may provide a geo-magnetic map corresponding to the second altitude. In another embodiment, the electronic device 101 may send only information on the altitude change rather than the absolute value of the second altitude to, e.g., the server. For example, the electronic device 101 may determine an altitude change AH occurs using, e.g., an air pressure sensor. In this case, the electronic device 101 may send a signal including the information on the altitude change AH to, e.g., the server. The server may determine that the current altitude of the electronic device 101 is the second altitude using the altitude change AH and the initial altitude (e.g., the first altitude) and send a geo-magnetic map corresponding to the second altitude to the electronic device 101 accordingly.

Meanwhile, a geo-magnetic map providing device (e.g., a server) may previously store a plurality of per-altitude geo-magnetic maps, and upon reception of altitude information from the electronic device 101, the geo-magnetic map providing device may provide a geo-magnetic map corresponding to the altitude. Or, the geo-magnetic map providing device, when receiving the altitude information from the electronic device 101, may generate a geo-magnetic map corresponding to the altitude and provide the generated geo-magnetic map to the electronic device 101.

In operation 1560, the electronic device 101 may compare a geo-magnetic map corresponding to the second altitude with second geo-magnetic data and determine the position of the electronic device 101 based on a result of the comparison. Here, the second geo-magnetic data may be geo-magnetic data sensed by the electronic device 101 at the second altitude.

As described above, the electronic device 101 may receive only the geo-magnetic map corresponding to the current altitude, not previously receiving all of the geo-magnetic maps for all of the altitudes, and use the same when determining a position.

Described above is a configuration in which the electronic device 101 selects a geo-magnetic map corresponding to the current altitude from among a plurality of geo-magnetic maps and compares the selected geo-magnetic map with a sensed geo-magnetic map to determine a position. A configuration in which the electronic device 101 determines the current altitude is described below in detail.

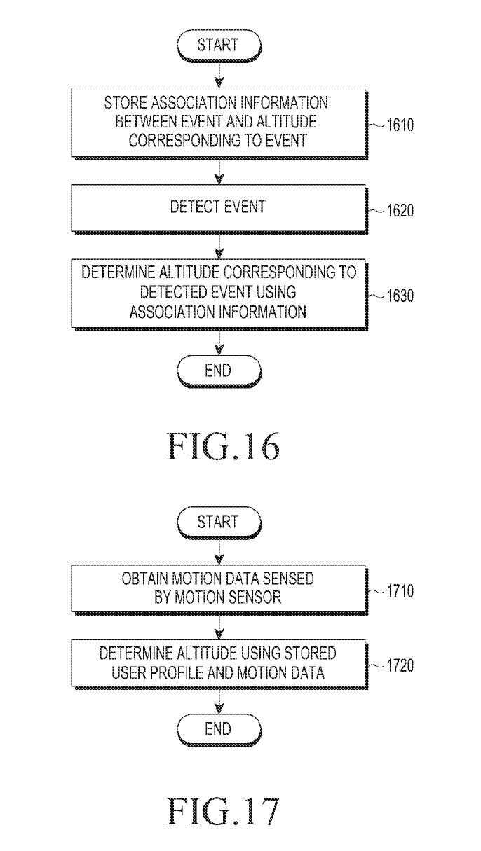

FIG. 16 is a flowchart illustrating a method for determining an altitude according to an embodiment of the present disclosure.

In operation 1610, the electronic device 101 may store information on an association between an event and an altitude corresponding to the event. For example, the electronic device 101 may store information on an association between an even as set forth in Table 1 and an altitude corresponding to the event.

TABLE 1

| Event | Altitude |
|---|---|
| Motion of swinging electronic device | T2 |
| Motion of staring at electronic device | T3 |
| Motion of taking phone | T5 |

In operation 1620, the electronic device 101 may detect an event. In operation 1630, the electronic device 101 may determine the altitude corresponding to the detected event using the association information. For example, the electronic device 101 may detect the action of swinging the electronic device and determine that the altitude of the electronic device 101 is T2. The electronic device 101 may receive and previously store the association information as set forth in Table 1. The association information may previously be created by various methods. For example, the creator may prepare the association information by identifying the altitude of the electronic device 101 per event according to an experiment and mapping the same. Or, the creator may prepare the association information by statistically processing various experimental results. In this case, the creator may set an event based on sensing data sensible by the electronic device 101. Alternatively, the association information may be prepared without involvement of the creator. According to an embodiment of the present disclosure, the electronic device creating the association information may apply an algorithm to various operations (e.g., a use history for sensing data or an application) and absolute altitude and may generate the association information between event and altitude using the result of applying the algorithm. For example, the electronic device creating the association information may generate the association between event and altitude using a result of applying a learning algorithm for correlations between various operations of the electronic device and altitudes. Meanwhile, it will easily be appreciated by one of ordinary skilled in the art that the above-described scheme for generating association information is merely an example and is not limited thereto. As described above, the electronic device 101 may exactly determine the absolute altitude.

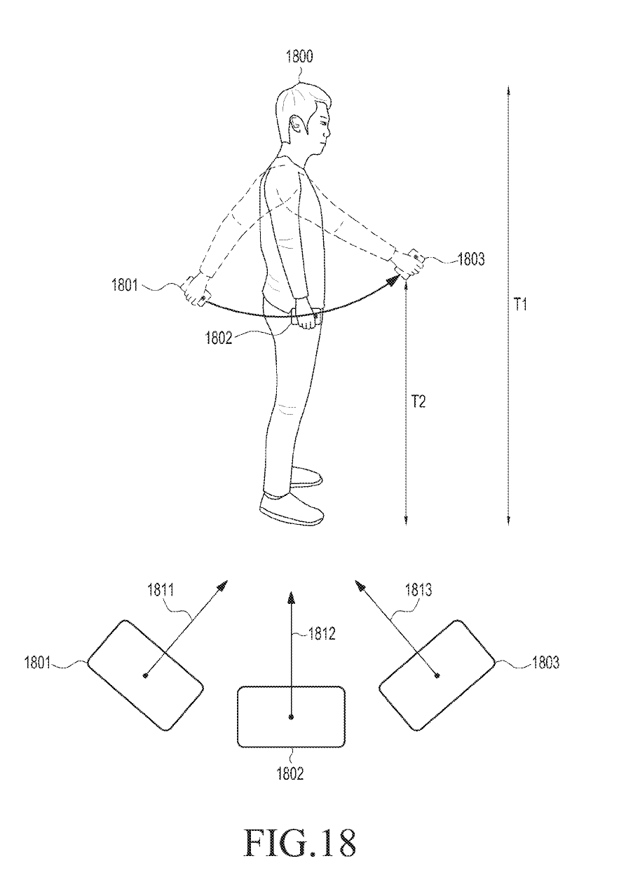

FIG. 17 is a flowchart illustrating a method for operating an electronic device.

In operation 1710, the electronic device 101 may obtain motion data sensed by a motion sensor. In operation 1720, the electronic device 101 may determine the altitude of the electronic device 101 using a user profile stored and the motion data. Specifically, the electronic device 101 may determine an event corresponding to the motion data. The electronic device 101 may determine an altitude based on the association information between event and altitude and the user profile. For example, the electronic device 101 may previously store association information as set forth in Table 2.

TABLE 2

| Event | Altitude |
|---|---|
| Motion of swinging electronic device | User's height × 0.6 |
| Motion of staring at electronic device | User's height × 0.8 |
| Motion of taking phone | User's height × 0.95 |

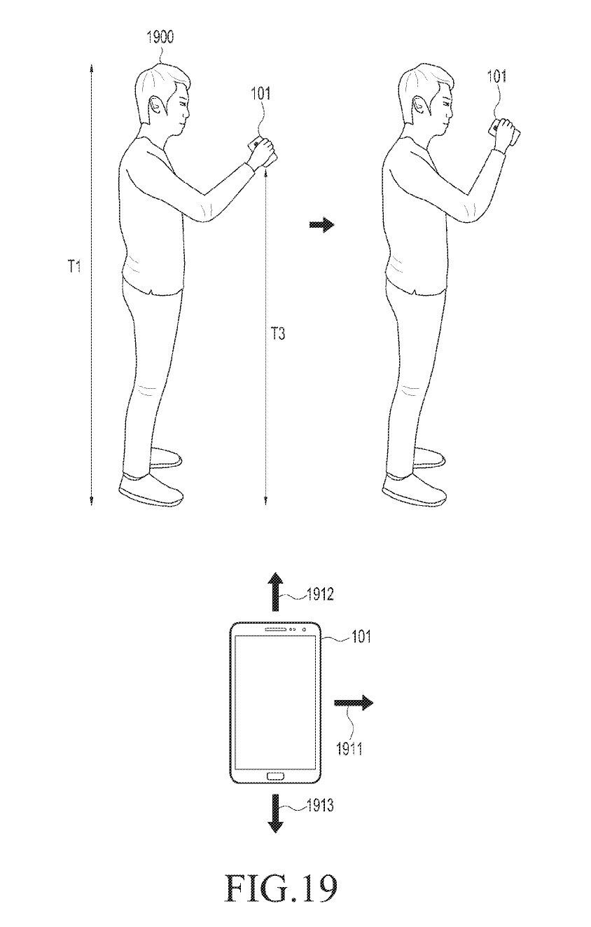

In contrast to that shown in Table 1, the association information set forth in Table 2 may include altitudes associated with the user's height, not the absolute altitude. Thus, even when the electronic device 101 is used by different users with different heights, a precise altitude may be obtained. For example, the electronic device 101 may determine that the electronic device 101 swings based on the motion data. When the electronic device 101 is determined to swing, the electronic device 101 may determine that the altitude of the electronic device 101 is the user's height×0.6. FIG. 18 is a concept view illustrating a swing of an electronic device 101.

As shown in FIG. 18, when the user 1800 holds and swings the electronic device 101, the electronic device 101 may be subject to a pendular motion. As shown on a lower part of FIG. 18, when subject to a pendular motion, the electronic device 101 may be applied with accelerations 1811, 1812, and 1813 by centripetal forces facing the center of the pendular motion at positions 1801, 1802, and 1803, respectively. For convenience, no acceleration of gravity is shown in FIG. 18. The electronic device 101 may sense the centripetal forces 1811, 1812, and 1813 through a motion sensor and determine the swing of the electronic device 101 based on the sensed motion data. The electronic device 101 may determine that the altitude of the electronic device 101 is the user's height (T1)×0.6=T2 based on the association information as set forth in Table 2, for example. The electronic device 101 may previously store the user's profile, e.g., the user's height (T1). As described above, when the altitude T2 is determined, the electronic device 101 may select a geo-magnetic map corresponding to the determined altitude T2 and may compare the selected geo-magnetic map with geo-magnetic data to determine the position of the electronic device 101. Meanwhile, alternatively, the electronic device 101 may immediately determine that the altitude is T2 using the association information as set forth in Table 1, but without using the user profile. The user profile may include various pieces of information, such as the user's gender, age, height, weight, and pace. The user profile may be entered by the user or may be determined by the electronic device 101 analyzing the user's behavior pattern.

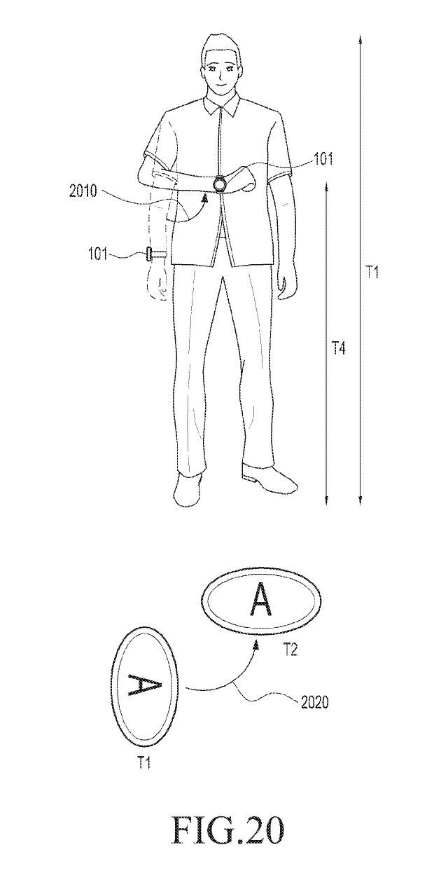

FIG. 19 is a concept view illustrating an event of viewing an electronic device according to an embodiment of the present disclosure.

As shown in FIG. 19, the user 1900 may walk staring at the electronic device 101. As shown on a lower part of FIG. 19, when the user walks in a particular direction while holding the electronic device 101, an acceleration 1911 in the particular direction may be applied in a horizontal direction of the electronic device 101. On the other hand, an acceleration in an upper direction and an acceleration 1913 in a lower direction may alternately be applied to the electronic device 101 by the user's walk. The electronic device 101 may sense the acceleration in the horizontal direction and upward/downward accelerations 1912 and 1913 in the vertical direction and may detect an event of a motion of staring at the electronic device 101 based on such motion data. The electronic device 101 may determine that the altitude of the electronic device 101 is the user's height (T1)×0.8=T3 based on the association information as set forth in Table 2, for example. The electronic device 101 may previously store the user's profile, e.g., the user's height (T1). As described above, when the altitude T3 is determined, the electronic device 101 may select a geo-magnetic map corresponding to the determined altitude T3 and may compare the selected geo-magnetic map with geo-magnetic data to determine the position of the electronic device 101. Meanwhile, alternatively, the electronic device 101 may immediately determine that the altitude is T3 using the association information as set forth in Table 1, but without using the user profile. Meanwhile, when the electronic device 101 detects a staring motion while detecting the swinging motion, the electronic device 101 may change the geo-magnetic map to be compared from the geo-magnetic map corresponding to the altitude of T2 to the geo-magnetic map corresponding to the altitude of T3. According to an embodiment of the present disclosure, the electronic device 101 may set a preset altitude, e.g., the height of the user's chest, as a reference, and may monitor detection of an event to trace the altitude.

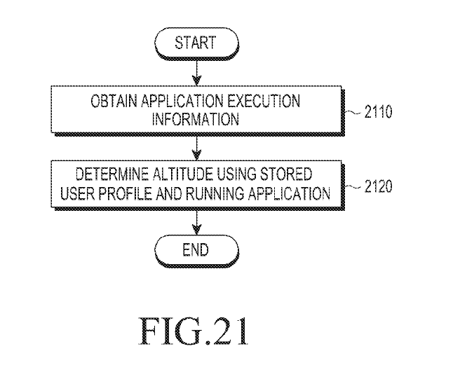

FIG. 20 is a concept view illustrating an event of viewing a wrist watch-type electronic device according to an embodiment of the present disclosure. The wrist watch-type electronic device may store association information between event and altitude as set forth in Table 3, for example.

TABLE 3

| Event | Altitude |
|---|---|
| Motion of swinging electronic device | User's height × 0.6 |
| Motion of staring at electronic device | User's height × 0.7 |
| Motion of taking phone | User's height × 0.95 |

In contrast to that set forth in Table 2, the association information shown in Table 3 may store information obtained by associating the altitude of the user's height×0.7 with the motion of staring at the electronic device. As set forth in Tables 2 and 3, different altitude information may be stored in association even for the same event depending on the type of the electronic device.

As shown in FIG. 20, the user hanging his arms freely with the electronic device 101 on may bend one of the arms. Accordingly, the electronic device 101 may move (2010) in an upper and left direction from the user's view. In this case, the electronic device 101 may sense an acceleration 2020 in the upper and left direction from the user's view as shown on a lower part of FIG. 20. The electronic device 101 may associate the acceleration 2020 in the upper and left direction from the user's view with a motion of staring at the electronic device and previously store the same. When determining that the motion data sensed through a motion sensor is the acceleration 2020 in the upper and left direction, the electronic device 101 may determine that an event of the motion of staring at the electronic device occurs.

The electronic device 101 may determine that the altitude of the electronic device 101 is the user's height (T1)×0.7=T4 based on the association information as set forth in Table 3, for example. The electronic device 101 may previously store the user's profile, e.g., the user's height (T1). As described above, when the altitude T4 is determined, the electronic device 101 may select a geo-magnetic map corresponding to the determined altitude T4 and may compare the selected geo-magnetic map with geo-magnetic data to determine the position of the electronic device 101. Meanwhile, alternatively, the electronic device 101 may immediately determine that the altitude is T4 using the association information including the absolute altitude, but without using the user profile.

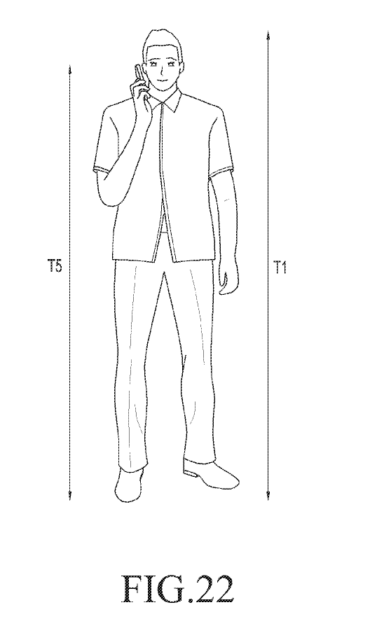

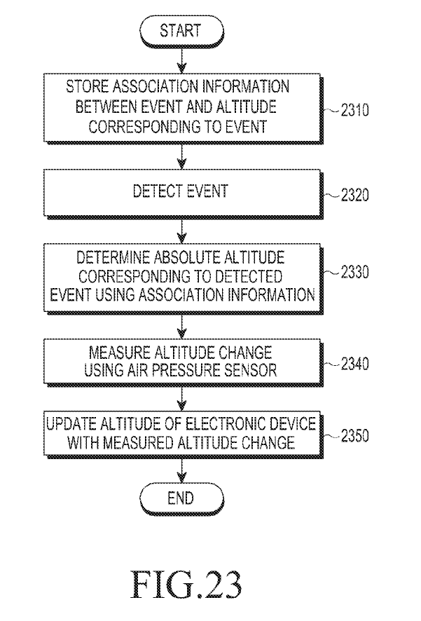

FIG. 21 is a flowchart illustrating an example of detecting an event of an electronic device and determining an altitude according to an embodiment of the present disclosure; The embodiment related to FIG. 21 is described in greater detail with reference to FIG. 22. FIG. 22 is a concept view illustrating an example of determining an altitude using application execution information according to an embodiment of the present disclosure.

In operation 2110, the electronic device 101 may obtain application execution information. In operation 2120, the electronic device 101 may determine an altitude using the running application and a stored user profile. For example, as shown in FIG. 22, the user may place or receive a phone call using the electronic device 101. In this case, the user may place the electronic device 101 near his ear. When a phone application runs, the electronic device 101 may determine that an event of the motion of receiving a phone call occurs. The electronic device 101 may determine that the altitude of the electronic device 101 is the user's height (T1)×0.95=T5 using the association information as set forth in Table 2, for example. Alternatively, the electronic device 101 may immediately determine T5, the absolute altitude, using, e.g., the association information as set forth in Table 1, but without using the user profile. The electronic device 101 may select a geo-magnetic map corresponding to the altitude T5 of the electronic device 101 and compare the sensed geo-magnetic data with the selected geo-magnetic map to determine the position of the electronic device 101.

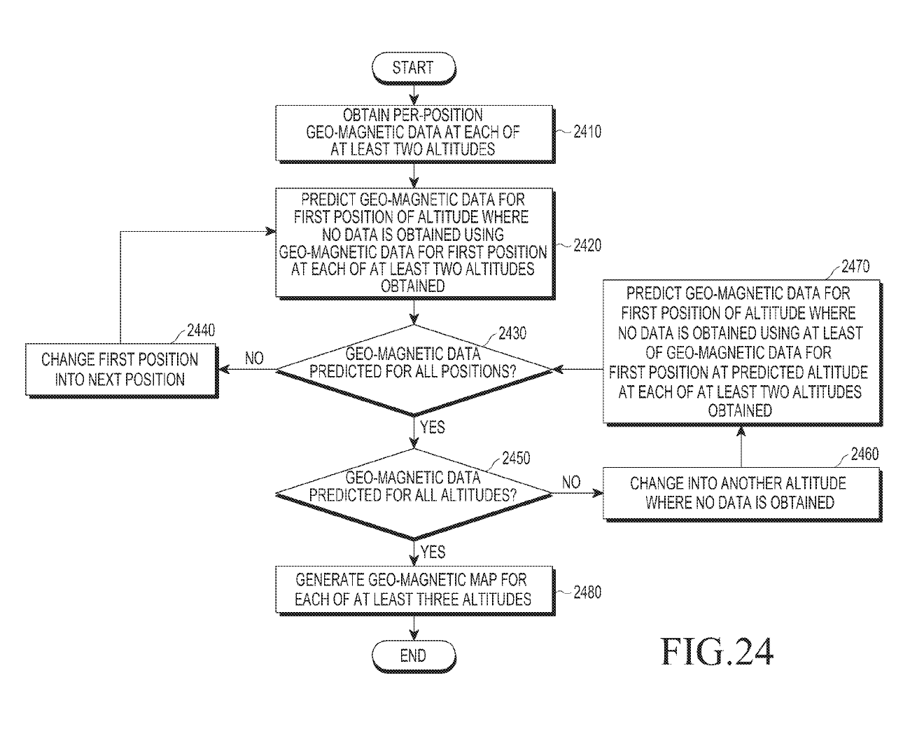

FIG. 23 is a flowchart illustrating an absolute altitude and update of an altitude according to an embodiment of the present disclosure.

In operation 2310, the electronic device 101 may previously store an event and association information corresponding to the event. In operation 2320, the electronic device 101 may detect an event. In operation 2330, the electronic device 101 may determine the absolute altitude corresponding to the detected event using the pre-stored association information. As described above, the electronic device 101 may determine the absolute altitude using, e.g., application execution information or sensing data obtained from various sensors, e.g., a motion sensor. Or, the electronic device 101 may determine the absolute altitude using the user profile, application execution information, or sensing data obtained from various sensors, e.g., a motion sensor.

In operation 2340, the electronic device 101 may determine an altitude change using an air pressure sensor. For example, the air pressure sensor of the electronic device 101 may sense the air pressure at the position of the electronic device 101. Since air pressure differs per altitude, the electronic device 101 may determine the altitude change using air pressure data sensed through the air pressure sensor. For example, when the air pressure data sensed by the electronic device 101 changes from first air pressure data to second air pressure data, the electronic device 101 may determine the altitude change depending on the degree of the change. In operation 2350, the electronic device 101 may update the current altitude of the electronic device according to the determined altitude change. For example, as the altitude change applies to the absolute altitude initially determined, the electronic device 101 may determine an updated altitude. When the altitude is updated, the electronic device 101 may select a geo-magnetic map corresponding to the updated altitude. The electronic device 101 may provide the position of the electronic device 101 by comparing the selected geo-magnetic map with geo-magnetic data sensed at the updated altitude.

As set forth above, the electronic device 101 may determine the absolute altitude corresponding to the occurrence of an event, and when the absolute altitude is determined, the electronic device 101 may then update the altitude by applying an altitude change based on sensing data using, e.g., an air pressure sensor. According to an embodiment of the present disclosure, the electronic device 101 may update the geo-magnetic map to be compared according to the altitude update and may thus adaptively provide the position of the electronic device 101.

A configuration in which the electronic device 101 determines an altitude has been described above. Now described in greater detail is a method for the electronic device 101 to generate a plurality of per-altitude geo-magnetic maps, i.e., a 3D geo-magnetic map.

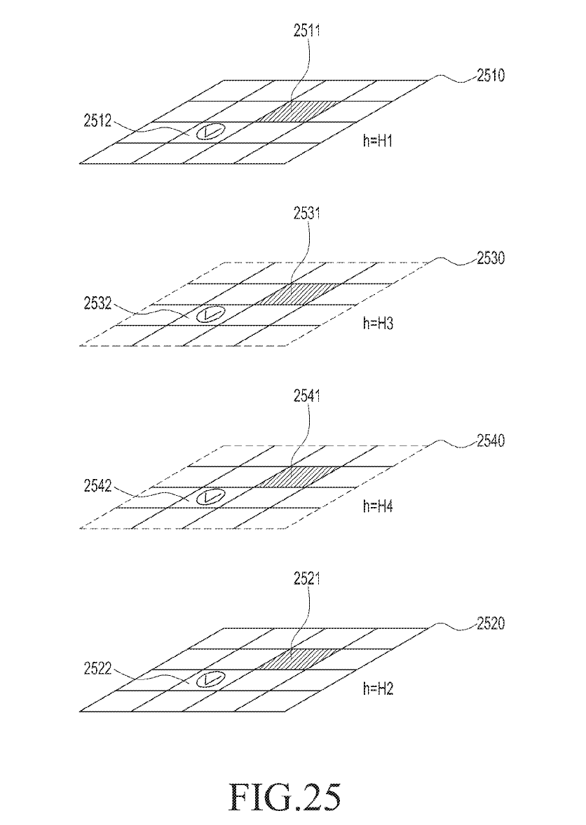

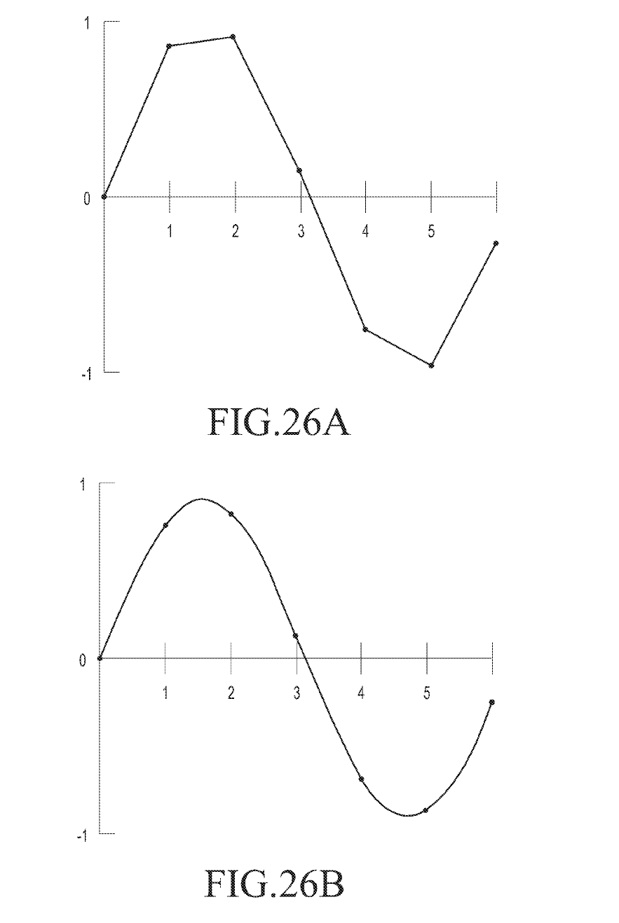

FIG. 24 is a flowchart illustrating a method for generating a plurality of per-altitude geo-magnetic maps according to an embodiment of the present disclosure. The embodiment related to FIG. 24 is described in greater detail with reference to FIG. 25. FIG. 25 is a concept view illustrating a process for generating a plurality of per-altitude geo-magnetic maps according to an embodiment of the present disclosure.

In operation 2410, according to an embodiment of the present disclosure, a device for generating a geo-magnetic map may obtain per-position geo-magnetic data at each of at least two altitudes. For example, as shown in FIG. 25, the geo-magnetic map generating device may obtain a geo-magnetic map 2510 corresponding to a first altitude H1 and a geo-magnetic map 2520 corresponding to a second altitude H2. For example, the geo-magnetic map generating device may obtain the geo-magnetic map 2510 corresponding to the first altitude H1 by directly visiting a particular area to sense geo-magnetic data at a plurality of positions while maintaining the first altitude H1. Further, the geo-magnetic map generating device may obtain the geo-magnetic map 2520 corresponding to the second altitude H2 by directly visiting a particular area to sense geo-magnetic data at a plurality of positions while maintaining the second altitude H2.

In operation 2420, the geo-magnetic map generating device may predict geo-magnetic data for a first position of an altitude, where no data is obtained, using geo-magnetic data for the first position at each of at least two altitudes obtained. For example, a process for the geo-magnetic map generating device to generate a geo-magnetic map corresponding to a third altitude (H3) is described with reference to FIG. 25. The geo-magnetic map generating device may predict geo-magnetic data at the first position 2531 of the third altitude H3 using geo-magnetic data at the first position 2511 of the first altitude H1 and geo-magnetic data at the first position 2521 of the second altitude H2. The geo-magnetic map generating device may predict geo-magnetic data at the first position 2531 of the third altitude H3 based on various interpolation schemes.

In operation 2430, the geo-magnetic map generating device may determine whether geo-magnetic data is predicted for all positions of an altitude where geo-magnetic data is intended to be generated. When geo-magnetic data is predicted for none of the positions, the geo-magnetic map generating device, in operation 2440, may change the first position into a next position, and the device, in operation 2420, may perform geo-magnetic data prediction. For example, as shown in FIG. 25, the geo-magnetic map generating device may predict the second position 2532 at the third altitude H3. Specifically, the geo-magnetic map generating device may predict geo-magnetic data at the second position 2532 of the third altitude H3 using geo-magnetic data at the second position 2512 of the first altitude H1 and geo-magnetic data at the second position 2522 of the second altitude H2. As described above, the geo-magnetic map generating device may predict geo-magnetic data at all positions of the third altitude H3 by changing positions for prediction, thereby generating a geo-magnetic map 2530 corresponding to the third altitude H3.

In operation 2450, the geo-magnetic map generating device may determine whether geo-magnetic data for all altitudes is predicted. When there is an altitude where geo-magnetic data is not predicted, the geo-magnetic map generating device, in operation 2460, may change the altitude of the geo-magnetic map to be generated into another altitude where no data is obtained. In operation 2470, the geo-magnetic map generating device may predict geo-magnetic data for a first position of an altitude, where no data is obtained, using at least one of geo-magnetic data for the first position at each of at least two altitudes obtained and geo-magnetic data for the first position at the predicted altitude. For example, as shown in FIG. 25, the geo-magnetic map generating device may predict geo-magnetic data at the first position 2541 of a fourth altitude H4. The geo-magnetic map generating device may predict geo-magnetic data at the first position 2541 of the fourth altitude H4 using the geo-magnetic data at the first position 2511 of the first altitude H1, the geo-magnetic data at the first position 2521 of the second altitude H2, i.e., the obtained geo-magnetic data, and the geo-magnetic data at the first position 2531 of the third altitude H3, i.e., the predicted geo-magnetic data. Alternatively, the geo-magnetic map generating device may predict the geo-magnetic data at the first position 2541 of the fourth altitude H4 using the geo-magnetic data at the first position 2511 of the first altitude H1, the geo-magnetic data at the first position 2521 of the second altitude H2, i.e., the obtained geo-magnetic data. The geo-magnetic map generating device may predict the geo-magnetic data at the second position 2542 of the fourth altitude H4 using the obtained geo-magnetic data and predicted geo-magnetic data or using the obtained geo-magnetic data.

In operation 2480, the geo-magnetic map generating device may generate a geo-magnetic map for each of at least three altitudes and may accordingly generate a plurality of per-altitude geo-magnetic maps, i.e., a 3D geo-magnetic map. The geo-magnetic map generating device may send the generated 3D geo-magnetic map to a server managing geo-magnetic maps or an electronic device entering the particular area.

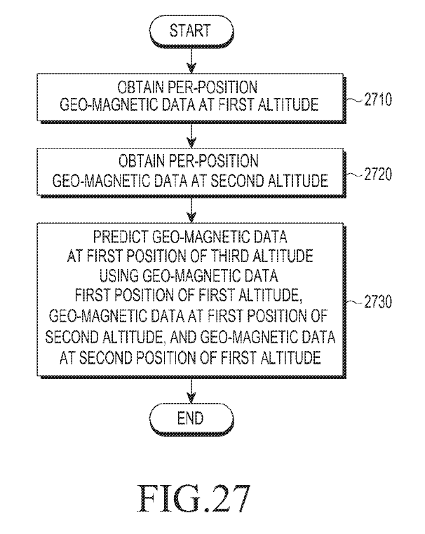

FIGS. 26a and 26b are graphs illustrating an interpolation method according to an embodiment of the present disclosure.

FIG. 26a illustrates interpolation data by a linear interpolation scheme. According to an embodiment of the present disclosure, a geo-magnetic map generating device may obtain geo-magnetic data at six heights (1 to 6) for a particular position and may apply a linear interpolation scheme to the geo-magnetic data at the six heights (1 to 6). Specifically, the geo-magnetic map generating device may connect geo-magnetic data at a first height 1 with geo-magnetic data at a second height 2 via a line. Accordingly, the geo-magnetic map generating device may predict geo-magnetic data at an nth height between the first height 1 and the second height 2.

FIG. 26b illustrates interpolation data by a polynomial interpolation scheme.

According to an embodiment of the present disclosure, a geo-magnetic map generating device may obtain geo-magnetic data at six heights (1 to 6) for a particular position and may apply a polynomial interpolation scheme to the geo-magnetic data at the six heights (1 to 6). Specifically, the geo-magnetic map generating device may generate a trend line for the geo-magnetic data at the six heights 1 to 6. Accordingly, the geo-magnetic map generating device may predict geo-magnetic data at an nth height between the first height 1 and the second height 2.

According to an embodiment of the present disclosure, the geo-magnetic map generating device may generate a plurality of per-altitude geo-magnetic maps by generating interpolation data using the polynomial interpolation scheme when previously generating a plurality of per-altitude geo-magnetic maps. Or, when receiving altitude information from the electronic device 101 and generating a geo-magnetic map for a corresponding altitude, the geo-magnetic map generating device may generate interpolation data using the linear interpolation scheme, thereby generating and providing interpolation data for the corresponding altitude.

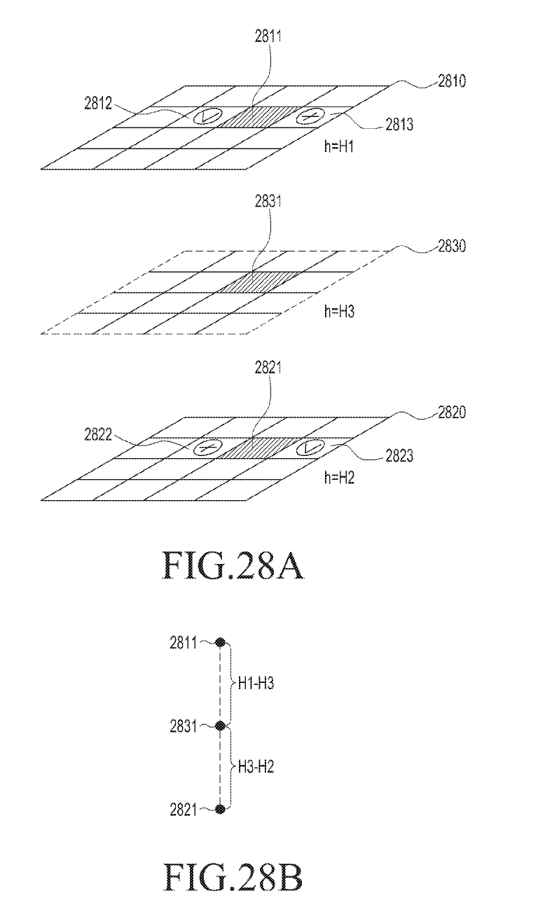

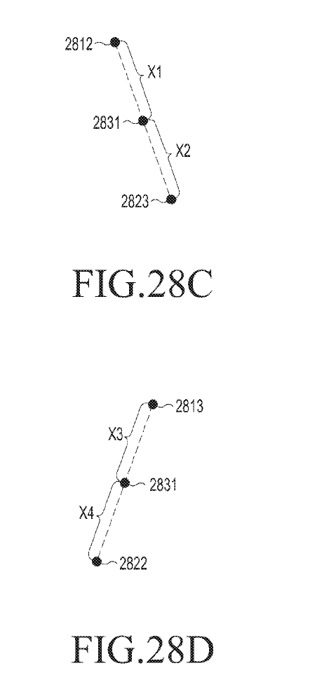

FIG. 27 is a flowchart illustrating a method for generating a plurality of per-altitude geo-magnetic maps according to an embodiment of the present disclosure. The embodiment related to FIG. 27 is described in greater detail with reference to FIGS. 28a to 28d. FIGS. 28a to 28d are concept views illustrating a process for generating a plurality of per-altitude geo-magnetic maps according to an embodiment of the present disclosure.

In operation 2710, the geo-magnetic map generating device may obtain per-position geo-magnetic data at a first altitude according to an embodiment of the present disclosure. In operation 2720, the geo-magnetic map generating device may obtain per-position geo-magnetic data at a second altitude. For example, as shown in FIG. 28a, the geo-magnetic map generating device may obtain a geo-magnetic map 2810 at the first altitude H1 and a geo-magnetic map 2820 at the second altitude H2.

In operation 2730, the geo-magnetic map generating device may predict geo-magnetic data at a first position of a third altitude using geo-magnetic data at the first position of the first altitude, geo-magnetic data at the first position of the second altitude, and geo-magnetic data at a second position of the first altitude. For example, the geo-magnetic map generating device is assumed to predict the geo-magnetic map 2830 at the third altitude H3 as shown in FIG. 28a. First, the geo-magnetic map generating device may predict geo-magnetic data at the first position 2831 from the geo-magnetic map 2830 for the third altitude H3. The geo-magnetic map generating device may predict geo-magnetic data using the first position 2811 of the first altitude H1 and the first position 2821 of the second altitude H2. Further, the geo-magnetic map generating device may predict the geo-magnetic data at the first position 2831 of the third altitude H3 additionally using the second position 2812 of the first altitude H1. For example, the geo-magnetic map generating device may predict a plurality of candidates for geo-magnetic data at the first position 2831 of the third altitude H3 using the first position 2811 of the first altitude H1 and the first position 2821 of the second altitude H2. The geo-magnetic map generating device may predict geo-magnetic data at the first position 2831 of the third altitude H3 among the plurality of candidates using the geo-magnetic data at the second position 2812 of the first altitude H1.

Or, as shown in FIG. 28b, the geo-magnetic map generating device may predict geo-magnetic data at the first position 2831 of the third altitude H3 by applying an interpolation method to the geo-magnetic data at the first position 2811 of the first altitude H1 and the geo-magnetic data at the first position 2821 of the second altitude H2. The geo-magnetic map generating device may apply the interpolation method further using inter-position distances H1-H3 and H3-H2. Further, as shown in FIG. 28c, the geo-magnetic map generating device may predict geo-magnetic data at the first position 2831 of the third altitude H3 by applying an interpolation method to the geo-magnetic data at the second position 2812 of the first altitude H1 and the geo-magnetic data at the third position 2823 of the second altitude H2. The geo-magnetic map generating device may apply the interpolation method further using inter-position distances X1 and X2. Further, as shown in FIG. 28d, the geo-magnetic map generating device may predict geo-magnetic data at the first position 2831 of the third altitude H3 by applying an interpolation method to the geo-magnetic data at the third position 2813 of the first altitude H1 and the geo-magnetic data at the second position 2822 of the second altitude H2. The geo-magnetic map generating device may apply the interpolation method further using inter-position distances X3 and X4. The geo-magnetic map generating device may predict geo-magnetic data at the first position 2831 of the third altitude H3 using at least one of the results obtained by applying the above-described three interpolation schemes. As set forth above, the geo-magnetic map generating device may exactly predict a plurality of per-altitude geo-magnetic maps even using two geo-magnetic maps.

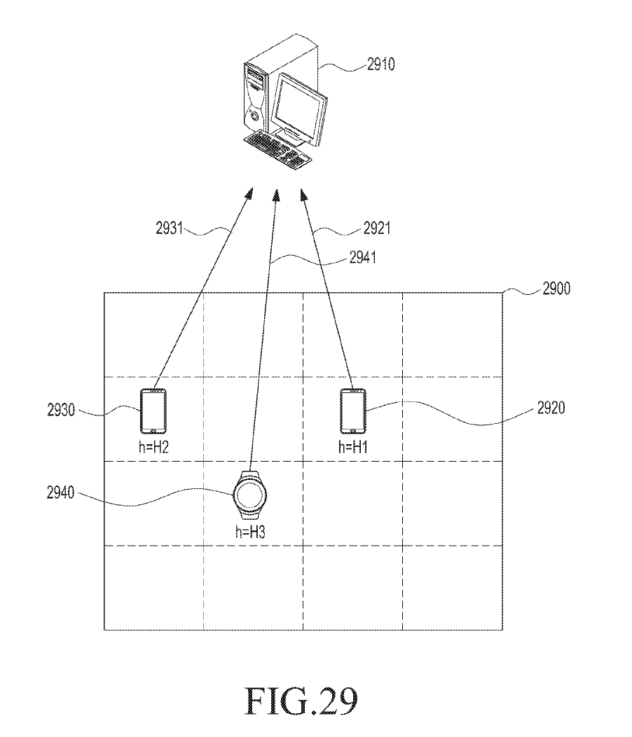

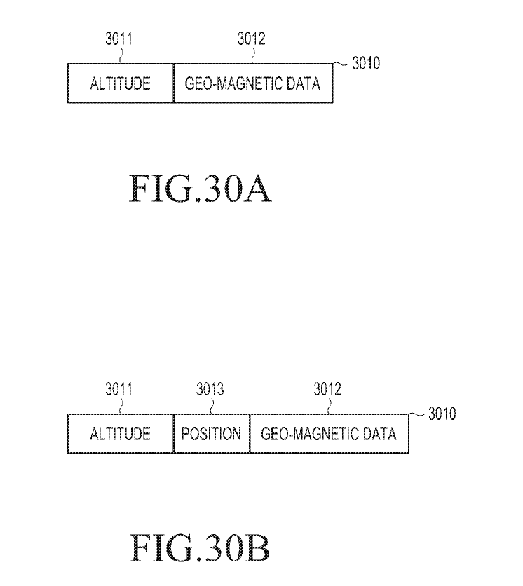

FIG. 29 is a concept view illustrating a process for updating a geo-magnetic map using crowd sourcing according to an embodiment of the present disclosure. An electronic device 2910 storing and managing geo-magnetic maps may previously store a plurality of per-altitude geo-magnetic maps. The electronic device 2910 may receive signals 2921, 2931, and 2941 from one or more other electronic devices 2920, 2930, and 2940, respectively, positioned in a particular area 2900. FIGS. 30a and 30b are concept views illustrating signals according to an embodiment of the present disclosure. A signal 3010 may include information on an altitude 3011 and information on geo-magnetic data 3012. For example, another electronic device 2920 may send, to the electronic device 2910, a signal 2921 including information on a first altitude H1 and sensed geo-magnetic data. The other electronic devices 2920, 2930, and 2940, each, may sense and send geo-magnetic data. The electronic device 2910 may update a geo-magnetic map previously stored using the received geo-magnetic data.

Alternatively, meanwhile, the other electronic devices 2920, 2930, and 2940 may send a signal as illustrated in FIG. 30b. The signal 3010 shown in FIG. 30b may further include location information 3013 as compared with that shown in FIG. 30a. The other electronic devices 2920, 2930, and 2940 may perform indoor positioning using other information than geomagnetic values. For example, the other electronic devices 2920, 2930, and 2940 may obtain the location information 3013 based on various pieces of information for indoor positioning such as pedestrian dead reckoning (PDR) information, wireless-fidelity (Wi-Fi) information, radio map information, or beacon radio map information. The other electronic devices 2920, 2930, and 2940 may map the obtained location information 3013 with altitude information 3011 and geo-magnetic data 3012 and send the same, and the electronic device 2910 may update the geo-magnetic map stored therein or generate a new geo-magnetic map using the same.

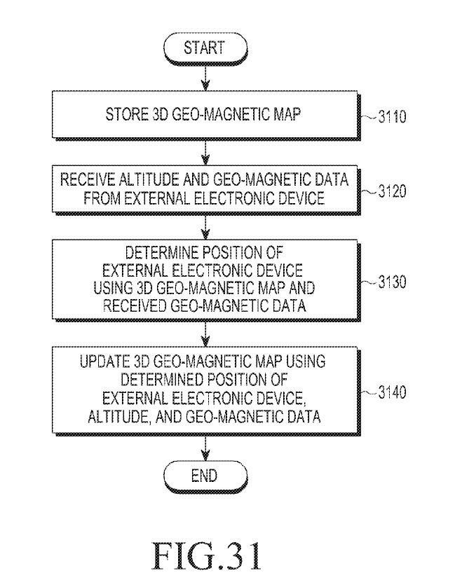

FIG. 31 is a flowchart illustrating a method for updating a geo-magnetic map according to an embodiment of the present disclosure.

In operation 3110, an electronic device storing and managing a 3D geo-magnetic map for a particular area may store a 3D geo-magnetic map. As set forth above, the electronic device may obtain at least two 2D geo-magnetic maps and generate and manage a plurality of per-altitude geo-magnetic maps using the obtained geo-magnetic maps.

In operation 3120, the electronic device may receive an altitude and geo-magnetic data from an external electronic device. For example, the electronic device may receive the altitude and geo-magnetic data from the external electronic device positioned in the particular area.

In operation 3130, the electronic device may determine the position of the external electronic device using the received geo-magnetic data and the 3D geo-magnetic map. For example, the electronic device may select a 2D geo-magnetic map corresponding to the altitude of the external electronic device and compare the selected geo-magnetic map with the received geo-magnetic data to determine the position of the external electronic device.

In operation 3140, the electronic device may update the 3D geo-magnetic map using the determined position of the external electronic device and the altitude and geo-magnetic data.

Meanwhile, according to an embodiment of the present disclosure, the electronic device may further receive additional information for positioning from another electronic device. For example, the electronic device may receive various data for indoor positioning from the other electronic device and determine the position of the other electronic device using the same. The electronic device may update the geo-magnetic map by mapping geo-magnetic data to the determined position of the other electronic device. In this case, the electronic device may generate a geo-magnetic map by mapping geo-magnetic data to the determined position of the other electronic device.

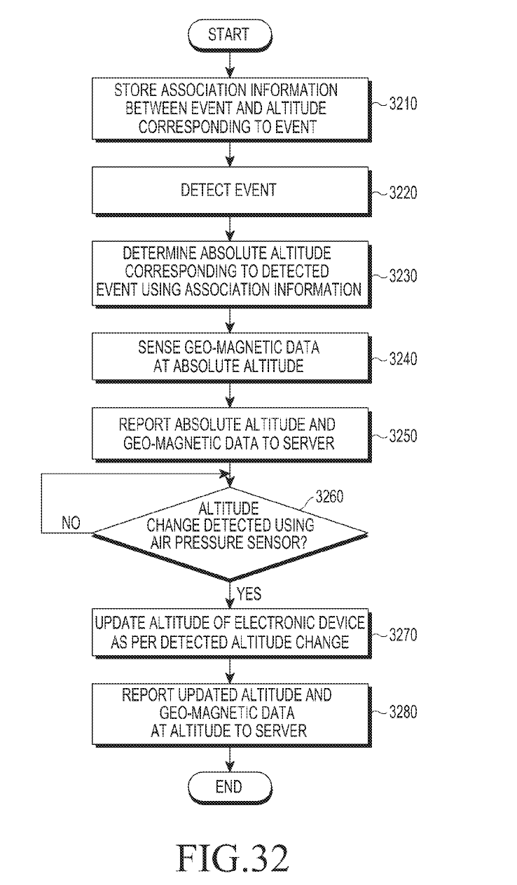

FIG. 32 is a flowchart illustrating an operation of an electronic device performing crowd sourcing according to an embodiment of the present disclosure.

In operation 3210, an electronic device may store information on an association between an event and an altitude corresponding to the event. For example, the electronic device may previously store association information as set forth in Tables 1 to 3. In operation 3220, the electronic device may detect an event. For example, the electronic device may detect the event using application execution information or data sensed by various sensors. In operation 3230, the electronic device may determine an absolute altitude corresponding to the detected event using the association information.

In operation 3240, the electronic device may sense geo-magnetic data at the corresponding absolute altitude. In operation 3250, the electronic device may report the absolute altitude and geo-magnetic data to a server. As described above, the server may update the geo-magnetic map or generate a new geo-magnetic map using the received absolute altitude and geo-magnetic data.

In operation 3260, the electronic device may detect a variation in altitude using an air pressure sensor. In operation 3270, the electronic device may update the altitude of the electronic device according to the detected variation in altitude. In operation 3280, the electronic device may report the updated altitude and geo-magnetic data at the altitude to the server. Thus, the server may update or generate geo-magnetic maps at various altitudes. Meanwhile, as described above, the electronic device may also report, to the server, additional information including at least one of PDR information, various data for positioning, or 2D location information that the electronic device obtains on its own. The server may update the geo-magnetic map or generate a new geo-magnetic map based on the received additional information and altitude information and geo-magnetic data.

According to an embodiment of the present disclosure, a method for operating an electronic device may comprise identifying an altitude of the electronic device, selecting one of a first geo-magnetic map and a second geo-magnetic map corresponding to the altitude of the electronic device, the first geo-magnetic map including geo-magnetic data for each of a plurality of positions at a first altitude in an area, and the second geo-magnetic map including geo-magnetic data for each of a plurality of positions at a second altitude in the area, comparing the selected geo-magnetic map with sensed geo-magnetic data, and providing a position of the electronic device using a result of the comparison.

According to an embodiment of the present disclosure, identifying the altitude of the electronic device may include measuring a motion of the electronic device and identifying the altitude of the electronic device using association information between a pre-stored motion of the electronic device and the altitude and the measured motion of the electronic device.

According to an embodiment of the present disclosure, identifying the altitude of the electronic device may include obtaining information on an application running on the electronic device and identifying the altitude of the electronic device using the obtained information on the running application and association information between the altitude of the electronic device and the information on the application running on the electronic device.

According to an embodiment of the present disclosure, the method may further comprise sensing an air pressure around the electronic device and updating the identified altitude of the electronic device using the air pressure around the electronic device.

According to an embodiment of the present disclosure, the method may further comprise selecting a geo-magnetic map corresponding to the updated altitude of the electronic device, comparing the geo-magnetic map corresponding to the updated altitude of the electronic device with geo-magnetic data sensed by a magnetic sensor at the updated altitude, and providing the position of the electronic device based on a result of the comparison.

According to an embodiment of the present disclosure, the method may further comprise receiving the first geo-magnetic map and the second geo-magnetic map from a server.

According to an embodiment of the present disclosure, providing the position of the electronic device using the result of the comparison may include identifying, as the position of the electronic device, a position mapped to geo-magnetic data having a difference from the sensed geo-magnetic data by less than a threshold on the selected geo-magnetic map.

According to an embodiment of the present disclosure, providing the position of the electronic device using the result of the comparison may include determining, as a position candidate, a first position mapped to the geo-magnetic data having the difference from the geo-magnetic data sensed by the magnetic sensor by less than the threshold on the selected geo-magnetic map at a first time and identifying the position of the electronic device at the first time from the position candidate based on whether the position candidate is positioned adjacent to a second position mapped to the geo-magnetic data having the difference from the geo-magnetic data sensed by the magnetic sensor by less than the threshold at a second time.

According to an embodiment of the present disclosure, a method for operating an electronic device, the method may comprise identifying an altitude of the electronic device, sensing geo-magnetic data, sending information on the altitude of the electronic device, receiving a geo-magnetic map corresponding to the altitude including geo-magnetic data for each of a plurality of positions in an area corresponding to the altitude of the electronic device, comparing the received geo-magnetic map with the sensed geo-magnetic data, and providing a position of the electronic device using a result of the comparison.

According to an embodiment of the present disclosure, the method may further comprise detecting a change in the altitude of the electronic device, sending information on the changed altitude, receiving a geo-magnetic map corresponding to the changed altitude including geo-magnetic data for each of the plurality of positions in the area corresponding to the changed altitude, comparing the received geo-magnetic map with the sensed geo-magnetic data, and providing a position of the electronic device using a result of the comparison.

Although the present disclosure has been described with various exemplary embodiments, various changes and modifications may be suggested to one skilled in the art. It is intended that the present disclosure encompass such changes and modifications as fall within the scope of the appended claims.

What is claimed is:

1. An electronic device, comprising:
a magnetic sensor;
a memory configured to store a first geo-magnetic map and a second geo-magnetic map, the first geo-magnetic map including geo-magnetic data for each of a plurality of positions at a first altitude in an area, and the second geo-magnetic map including geo-magnetic data for each of the plurality of positions at a second altitude in the area; and
a processor configured to:
identify an altitude of the electronic device,
select one of the first geo-magnetic map and the second geo-magnetic map corresponding to the altitude of the electronic device,
compare the selected geo-magnetic map with geo-magnetic data sensed by the magnetic sensor, and
provide a position of the electronic device using a result of the comparison.

2. The electronic device of claim 1, wherein the memory is further configured to store association information between the altitude of the electronic device and an event detected by the electronic device.

3. The electronic device of claim 2, further comprising a motion sensor configured to measure a motion of the electronic device,
wherein the stored association information further includes association information between data sensed by the motion sensor and the altitude of the electronic device, and
wherein the processor is configured to identify the altitude of the electronic device using the association information and the data sensed by the motion sensor.

4. The electronic device of claim 2, wherein the association information further includes association information between the altitude of the electronic device and information on an application running on the electronic device, and
wherein the processor is configured to identify the altitude of the electronic device using the information on the application running on the electronic device.

5. The electronic device of claim 1, further comprising an air pressure sensor configured to sense an air pressure around the electronic device,
wherein the processor is configured to update the identified altitude of the electronic device using data sensed by the air pressure sensor.

6. The electronic device of claim 5, wherein the processor is configured to:
select a geo-magnetic map corresponding to the updated altitude of the electronic device,
compare the geo-magnetic map corresponding to the updated altitude of the electronic device with geo-magnetic data sensed by the magnetic sensor at the updated altitude, and
provide the position of the electronic device based on a result of the comparison.

7. The electronic device of claim 1, further comprising a communication interface configured to receive the first geo-magnetic map and the second geo-magnetic map from a server.

8. The electronic device of claim 1, wherein the processor is configured to:
determine, as the position of the electronic device, a position mapped to geo-magnetic data having a difference from the geo-magnetic data sensed by the magnetic sensor, the difference being less than a threshold on the selected geo-magnetic map.

9. The electronic device of claim 8, wherein the processor is configured to:
determine, as a position candidate, at a first time, a first position mapped to the geo-magnetic data having the difference of less than the threshold, from the geo-magnetic data sensed by the magnetic sensor, and
identify the position of the electronic device at the first time, from the position candidate, based on whether the position candidate is positioned, at a second time, adjacent to a second position mapped to the geo-magnetic data having the difference of less than the threshold, from the geo-magnetic data sensed by the magnetic sensor.

10. An electronic device, comprising:
a magnetic sensor;
a communication interface; and
a processor configured to:
identify an altitude of the electronic device,
send information on the altitude of the electronic device through the communication interface,
receive a first geo-magnetic map corresponding to the altitude including geo-magnetic data for each of a plurality of positions in an area corresponding to the altitude of the electronic device through the communication interface,
compare the received first geo-magnetic map with geo-magnetic data sensed by the magnetic sensor, and
provide a position of the electronic device using a result of the comparison.

11. The electronic device of claim 10, wherein the processor is configured to:
detect a change in the altitude of the electronic device,
send information on the changed altitude through the communication interface,
receive a second geo-magnetic map corresponding to the changed altitude including geo-magnetic data for each of the plurality of positions in the area corresponding to the changed altitude through the communication interface,
compare the received second geo-magnetic map with the sensed geo-magnetic data, and
provide a position of the electronic device using a result of the comparison.

12. A method for operating an electronic device, the method comprising:
identifying an altitude of the electronic device;
selecting one of a first geo-magnetic map and a second geo-magnetic map corresponding to the altitude of the electronic device, the first geo-magnetic map including geo-magnetic data for each of a plurality of positions at a first altitude in an area, and the second geo-magnetic map including geo-magnetic data for each of the plurality of positions at a second altitude in the area;
comparing the selected geo-magnetic map with sensed geo-magnetic data; and
providing a position of the electronic device using a result of the comparison.

13. The method of claim 12, wherein identifying the altitude of the electronic device includes:
measuring a motion of the electronic device, and
identifying the altitude of the electronic device using association information between a pre-stored motion of the electronic device and the altitude, and the measured motion of the electronic device.

14. The method of claim 12, wherein identifying the altitude of the electronic device includes:
obtaining information on an application running on the electronic device, and
identifying the altitude of the electronic device using the obtained information on the application running on the electronic device, and association information between the altitude of the electronic device and the information on the application running on the electronic device.

15. The method of claim 12, further comprising:
sensing an air pressure around the electronic device; and
updating the identified altitude of the electronic device using the sensed air pressure around the electronic device.

16. The method of claim 15, further comprising:
selecting a geo-magnetic map corresponding to the updated altitude of the electronic device;
comparing the selected geo-magnetic map corresponding to the updated altitude of the electronic device with geo-magnetic data sensed by a magnetic sensor disposed at the updated altitude; and
providing the position of the electronic device based on a result of the comparison.

17. The method of claim 12, further comprising receiving the first geo-magnetic map and the second geo-magnetic map from a server.

18. The method of claim 12, wherein providing the position of the electronic device using the result of the comparison includes:
identifying, as the position of the electronic device, a position mapped to geo-magnetic data having a difference from the sensed geo-magnetic data of less than a threshold on the selected geo-magnetic map.

19. The method of claim 18, wherein providing a first position of the electronic device using the result of the comparison includes:
determining, as a position candidate, the position mapped to the geo-magnetic data having the difference from the geo-magnetic data, sensed by a magnetic sensor, of less than the threshold on the selected geo-magnetic map at a first time, and
identifying the position of the electronic device at the first time from the position candidate based on whether the position candidate is positioned adjacent to a second position mapped to the geo-magnetic data having the difference from the geo-magnetic data, sensed by the magnetic sensor, of less than the threshold at a second time.

20. A method for operating an electronic device, the method comprising:
identifying an altitude of the electronic device;
sensing geo-magnetic data;
sending information on the altitude of the electronic device;
receiving a geo-magnetic map corresponding to the altitude including geo-magnetic data for each of a plurality of positions in an area corresponding to the altitude of the electronic device;
comparing the received geo-magnetic map with the sensed geo-magnetic data; and
providing a position of the electronic device using a result of the comparison.

21. The method of claim 20, further comprising:
detecting a change in the altitude of the electronic device;
sending information on the changed altitude;
receiving a geo-magnetic map corresponding to the changed altitude including geo-magnetic data for each of the plurality of positions in the area corresponding to the changed altitude;
comparing the received geo-magnetic map with the sensed geo-magnetic data; and
providing a position of the electronic device using a result of the comparison.

22. An electronic device, comprising:
a memory configured to store a first geo-magnetic map and a second geo-magnetic map, the first geo-magnetic map including geo-magnetic data for each of a plurality of positions at a first altitude in an area, and the second geo-magnetic map including geo-magnetic data for each of a plurality of positions at a second altitude in the area; and
a processor configured to generate a third geo-magnetic map including geo-magnetic data for each of a plurality of positions at a third altitude located between the first altitude and the second altitude, using the first geo-magnetic map and the second geo-magnetic map.

23. The electronic device of claim 22, further comprising a communication interface,
wherein the processor is configured to detect an entry of another electronic device into the area and send the first geo-magnetic map, the second geo-magnetic map, and the third geo-magnetic map to the another electronic device through the communication interface.

24. The electronic device of claim 22, further comprising a communication interface,
wherein the processor is configured to:
receive information on an altitude of another electronic device from the another electronic device through the communication interface,
select a geo-magnetic map corresponding to the altitude of the another electronic device from among the first geo-magnetic map, the second geo-magnetic map, and the third geo-magnetic map, and
send the selected geo-magnetic map to the another electronic device through the communication interface.

25. The electronic device of claim 22, wherein the processor is configured to:
apply an interpolation scheme to the first geo-magnetic map and the second geo-magnetic map, and
generate the third geo-magnetic map using a result of the application of the interpolation scheme.

26. The electronic device of claim 25, wherein the processor is configured to:
apply the interpolation scheme to geo-magnetic data at a first position of the first geo-magnetic map and geo-magnetic data at a first position of the second geo-magnetic map, and
obtain geo-magnetic data at a first position of the third geo-magnetic map using a result of the application of the interpolation scheme.

27. The electronic device of claim 26, wherein the processor is configured to obtain the geo-magnetic data at the first position of the third geo-magnetic map using the geo-magnetic data at the second position of the first geo-magnetic map and the result of the application of the interpolation scheme.

28. A method for operating an electronic device, the method comprising:
obtaining a first geo-magnetic map including geo-magnetic data for each of a plurality of positions at a first altitude in an area;
obtaining a second geo-magnetic map including geo-magnetic data for each of the plurality of positions at a second altitude in the area; and
generating a third geo-magnetic map including geo-magnetic data for each of the plurality of positions at a third altitude between the first altitude and the second altitude using the first geo-magnetic map and the second geo-magnetic map.

29. The method of claim 28, further comprising:
detecting an entry of another electronic device into the area; and
sending the first geo-magnetic map, the second geo-magnetic map, and the third geo-magnetic map to the another electronic device.

30. The method of claim 29, further comprising:
receiving information on an altitude of the another electronic device from the another electronic device;
selecting a geo-magnetic map corresponding to the altitude of the another electronic device from among the first geo-magnetic map, the second geo-magnetic map, and the third geo-magnetic map; and
sending the selected geo-magnetic map to the another electronic device.

31. The method of claim 28, wherein generating the third geo-magnetic map includes:
applying an interpolation scheme to the first geo-magnetic map and the second geo-magnetic map, and
generating the third geo-magnetic map using a result of the application of the interpolation scheme.

32. The method of claim 31, wherein generating the third geo-magnetic map includes:
applying the interpolation scheme to geo-magnetic data at a first position of the first geo-magnetic map and geo-magnetic data at a first position of the second geo-magnetic map, and
obtaining geo-magnetic data at a first position of the third geo-magnetic map using a result of the application of the interpolation scheme.

33. The method of claim 32, wherein generating the third geo-magnetic map includes:
obtaining the geo-magnetic data at the first position of the third geo-magnetic map using the geo-magnetic data at the second position of the first geo-magnetic map and the result of the application of the interpolation scheme.
